(19) United States
(12) Patent Application Publication
(10) Pub. No.: US 2011/0265118 A1
(43) Pub. Date: Oct. 27, 2011

(54) IMAGE DISPLAY APPARATUS AND METHOD FOR OPERATING THE SAME

(76) Inventors: Hyunbo CHOI, Seoul (KR); Youngho Jeong, Seoul (KR)

(21) Appl. No.: 12/972,353

(22) Filed: Dec. 17, 2010

Related U.S. Application Data
(60) Provisional application No. 61/353,588, filed on Jun. 10, 2010.
(60) Provisional application No. 61/352,713, filed on Jun. 8, 2010.

(30) Foreign Application Priority Data
Apr. 21, 2010 (KR) 10-2010-0036985
Jun. 8, 2010 (KR) 10-2010-0053877

(51) Int. Cl. H04N 5/445

(52) U.S. Cl. 725/37

(57) ABSTRACT

An image display apparatus and a method for operating the same are discussed. The method according to an embodiment includes displaying an image on a display, selecting, when a pointer displayed in response to movement of a remote controller is dragged from a first position to a second position on the display, an area corresponding to the first position and the second position, and performing, under a condition that the selection area is pointed out and a first button of the remote controller is pressed, if the remote controller moves away from the display or approaches the display, a zoom-in or zoom-out operation of the selection area, and displaying the zoomed-in or zoomed-out result on the display. As a result, user convenience is increased.

### CROSS-REFERENCE TO RELATED APPLICATION

This application claims the benefit of Korean Patent Application Nos. 10-2010-0036985, filed on Apr. 21, 2010 and 10-2010-0053877, filed on Jun. 8, 2010 in the Korean Intellectual Property Office and the benefit of U.S. Provisional Application Nos. 61/353,588 filed on Jun. 10, 2010 and 61/352,713, filed on Jun. 8, 2010 in the USPTO. The entire contents of all these applications are incorporated herein by reference.

### BACKGROUND OF THE INVENTION

1. Field of the Invention

The present invention relates to an image display apparatus and a method for operating the same, and more particularly, to an image display apparatus and a method for operating the same, which increase user convenience.

2. Description of the Related Art

An image display apparatus has a function of displaying images to a user. The image display apparatus can display a broadcast program selected by the user on a display from among broadcast programs transmitted from broadcasting stations. The recent trend in broadcasting is a worldwide shift from analog broadcasting to digital broadcasting.

As it transmits digital audio and video signals, digital broadcasting offers many advantages over analog broadcasting, such as robustness against noise, less data loss, ease of error correction, and the ability to provide high-definition, clear images. Digital broadcasting also allows interactive viewer services, compared to analog broadcasting.

### SUMMARY OF THE INVENTION

Therefore, the present invention has been made in view of the above problems, and it is an object of the present invention to provide an image display apparatus and a method for operating the same, which can increase user convenience.

It is another object of the present invention to provide an image display apparatus and a method for operating the same, which can enable a user to easily obtain desired information.

It is another object of the present invention to provide an image display apparatus and a method for operating the same, which display the list of contents in response to the searching result classified according to source items.

It is another object of the present invention to provide an image display apparatus and a method for operating the same, which can provide various user interfaces.

In accordance with an aspect of the present invention, the above and other objects can be accomplished by the provision of a method for operating an image display apparatus, including displaying an image on a display, selecting, when a pointer displayed in response to movement of a remote controller is dragged from a first position to a second position on the display, an area corresponding to the first position and the second position, and performing, under a condition that the selection area is pointed out and a first button of the remote controller is pressed, if the remote controller moves away from the display or approaches the display, a zoom-in or zoom-out operation of the selection area, and displaying the zoomed-in or zoomed-out result on the display.

In accordance with another aspect of the present invention, there is provided a method for operating an image display apparatus including displaying an image on a display, selecting, when a pointer displayed in response to movement of a remote controller is rotated, an area corresponding to a rotation movement path of the pointer, and performing, under a condition that the selection area is pointed out and a first button of the remote controller is pressed, if the remote controller moves away from the display or approaches the display, a zoom-in or zoom-out operation of the selection area, and displaying the zoomed-in or zoomed-out result on the display.

In accordance with another aspect of the present invention, there is provided a method for operating an image display apparatus including displaying an image on a display, selecting at least one object from among the image, and performing, under a condition that a first button of the remote controller is pressed, if the remote controller moves away from the display or approaches the display, a zoom-in or zoom-out operation of the selected object, and displaying the zoomed-in or zoomed-out result on the display.

In accordance with another aspect of the present invention, there is provided an image display apparatus including a display for displaying an image, a remote controller for transmitting a control signal, and a controller for controlling, when a pointer displayed in response to movement of the remote controller is dragged from a first position to a second position on the display, an area corresponding to the first position and the second position to be selected, performing, under a condition that the selection area is pointed out and a first button of the remote controller is pressed, if the remote controller moves away from the display or approaches the display, a zoom-in or zoom-out operation of the selection area, and displaying the zoomed-in or zoomed-out result on the display.

In accordance with another aspect of the present invention, there is provided an image display apparatus including a display for displaying an image, a remote controller for transmitting a control signal, and a controller for controlling, when a pointer displayed in response to movement of a remote controller is rotated, an area corresponding to a rotation movement path of the pointer to be selected, performing, under a condition that the selection area is pointed out and a first button of the remote controller is pressed, if the remote controller moves away from the display or approaches the display, a zoom-in or zoom-out operation of the selection area, and displaying the zoomed-in or zoomed-out result on the display.

In accordance with another aspect of the present invention, there is provided an image display apparatus including a display for displaying an image, a remote controller for transmitting a control signal, and a controller for performing, under a condition that at least one object is selected from among the image and a first button of the remote controller is pressed, if the remote controller moves away from the display or approaches the display, a zoom-in or zoom-out operation of the selected object, and displaying the zoomed-in or zoomed-out result on the display.

In accordance with another aspect of the present invention, there is provided a method, computer program product and apparatus for displaying an image on an image display apparatus; displaying a pointer on the image, the pointer corresponding to an orientation or position of a remote controller relative to the image display apparatus; selecting, in response to a first command from the remote controller, an object or an area in the displayed image; and displaying, in response to a second command from the remote controller, a zoom-in or zoom-out of the selected object or area in the displayed image.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates the overall configuration of a broadcasting system including an image display apparatus according to an embodiment of the present invention.

FIG. 2 illustrates the overall configuration of a broadcasting system including an image display apparatus according to another embodiment of the present invention.

FIG. 3 is a diagram illustrating a signal flow for an operation for attaching to a Service Provider (SP) and receiving channel information from the SP in the image display apparatus illustrated in FIG. 1 or 2 according to an embodiment of the present invention.

FIG. 4 illustrates an example of data used in the operation illustrated in FIG. 3.

FIG. 5 is a detailed block diagram of the image display apparatus illustrated in FIG. 1 or 2 according to an embodiment of the present invention.

FIG. 6 is a detailed block diagram of the image display apparatus illustrated in FIG. 1 or 2 according to another embodiment of the present invention.

FIGS. 7 and 8 are block diagrams illustrating either of the image display apparatuses separately as a set-top box and a display device according to embodiments of the present invention.

FIG. 9 illustrates an operation for communicating with third devices in either of the image display apparatuses according to an embodiment of the present invention.

FIG. 10 is a block diagram of a controller illustrated in FIG. 6.

FIG. 11 illustrates a platform architecture for either of the image display apparatuses according to an embodiment of the present invention.

FIG. 12 illustrates a platform architecture for either of the image display apparatuses according to another embodiment of the present invention.

FIG. 13 illustrates a method for controlling either of the image display apparatuses in a remote controller according to an embodiment of the present invention.

FIG. 14 is a detailed block diagram of the remote controller in either of the image display apparatuses according to an embodiment of the present invention.

FIG. 15 illustrates a UI in either of the image display apparatuses according to an embodiment of the present invention.

FIG. 16 illustrates a UI in either of the image display apparatuses according to another embodiment of the present invention.

FIG. 17 illustrates a UI in either of the image display apparatuses according to another embodiment of the present invention.

FIG. 18 illustrates a UI in either of the image display apparatuses according to a further embodiment of the present invention.

FIG. 19 is a flowchart illustrating a method for operating an image display apparatus according to embodiments of the present invention.

FIGS. 20 to 31 are views referred to for describing various examples of a method for operating an image display apparatus, illustrated in FIG. 19.

FIG. 32 is a flowchart illustrating a method for operating an image display apparatus according to embodiments of the present invention.

FIGS. 33A to 37B are views referred to for describing various examples of a method for operating an image display apparatus, illustrated in FIG. 32.

### DETAILED DESCRIPTION OF THE PREFERRED EMBODIMENTS

Embodiments of the present invention will be described below with reference to the attached drawings.

The terms “module” and “unit” used to signify components are used herein to help the understanding of the components and thus they should not be considered as having specific meanings or roles. Accordingly, the terms “module” and “unit” may be used interchangeably.

An image display apparatus as set forth herein is an intelligent image display apparatus equipped with a computer support function in addition to a broadcast reception function, for example. Thus the image display apparatus may have user-friendly interfaces such as a handwriting input device, a touch screen, or a pointing device. Further, because the image display apparatus supports wired or wireless Internet, it is capable of e-mail transmission/reception, Web browsing, banking, gaming, etc. by connecting to the Internet or a computer. To implement these functions, the image display apparatus may operate based on a standard general-purpose Operating System (OS).

Various applications can be freely added to or deleted from, for example, a general-purpose OS kernel in the image display apparatus according to the present invention. Therefore, the image display apparatus may perform a number of user-friendly functions. The image display apparatus may be a network TV, a Hybrid broadcast broadband TV (HbbTV), a smart TV, etc. for example. The image display apparatus is applicable to a smart phone, as needed.

Embodiments of the present invention will be described in detail with reference to the attached drawings, but it should be understood that they are merely illustrative of the present invention and should not be interpreted as limiting the scope of the present invention.

In addition, although the terms used in the present invention are selected from generally known and used terms, some of the terms mentioned in the description of the present invention, the detailed meanings of which are described in relevant parts of the description herein, have been selected by the applicant at his or her discretion. Furthermore, the present invention must be understood, not simply by the actual terms used but by the meanings of each term lying within.

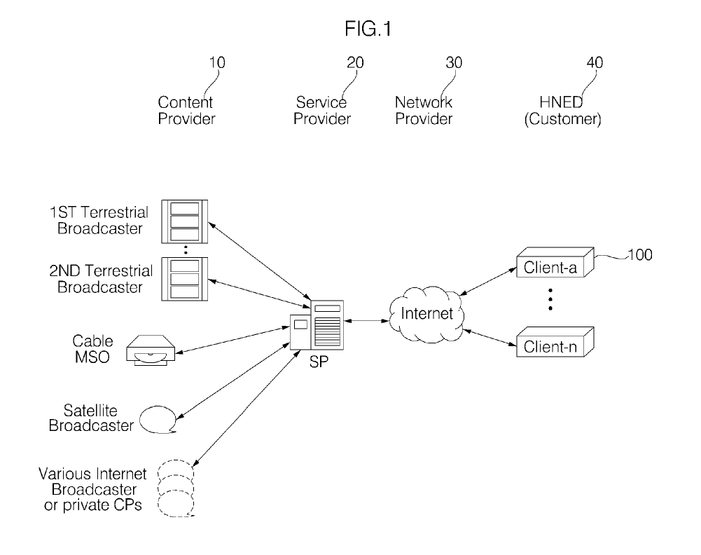

FIG. 1 illustrates the overall configuration of a broadcasting system including an image display apparatus according to an embodiment of the present invention.

Referring to FIG. 1, the broadcasting system may include a Content Provider (CP) 10, a Service Provider (SP) 20, a Network Provider (NP) 30, and a Home Network End Device (HNED) 40. The HNED 40 corresponds to, for example, a client 100 which is an image display apparatus according to an embodiment of the present invention. As stated before, the image display apparatus may be a network TV, a smart TV, an Internet Protocol TV (IPTV), etc.

The CP 10 creates and provides content. The CP 10 may be, for example, a terrestrial broadcaster, a cable System Operator (SO) or Multiple System Operator (MSO), a satellite broadcaster, or an Internet broadcaster, as illustrated in FIG. 1.

Besides broadcast content, the CP 10 may provide various applications, which will be described later in detail.

The SP 20 may provide content received from the CP 10 in a service package. For instance, the SP 20 may package first terrestrial broadcasting, second terrestrial broadcasting, cable broadcasting, satellite broadcasting, Internet broadcasting, and applications and provide the package to users.

The SP 20 may unicast or multicast a service to the client 100. Unicast is a form of transmission in which information is sent from only one transmitter to only one receiver. In other words, unicast transmission is point-to-point, involving two nodes only. In an example of unicast transmission, upon receipt of a request for data from a receiver, a server transmits the data to only one receiver. Multicast is a type of transmission or communication in which a transmitter transmits data to a group of receivers. For example, a server may transmit data to a plurality of pre-registered receivers at one time. For multicast registration, the Internet Group Management Protocol (IGMP) may be used.

The NP 30 may provide a network over which a service is provided to the client 100. The client 100 may construct a home network and receive a service over the home network.

Content transmitted in the above-described broadcasting system may be protected through conditional access or content protection. CableCard and Downloadable Conditional Access System (DCAS) are examples of conditional access or content protection.

The client 100 may also transmit content over a network. In this case, the client 100 serves as a CP and thus the CP 10 may receive content from the client 100. Therefore, an interactive content service or data service can be provided.

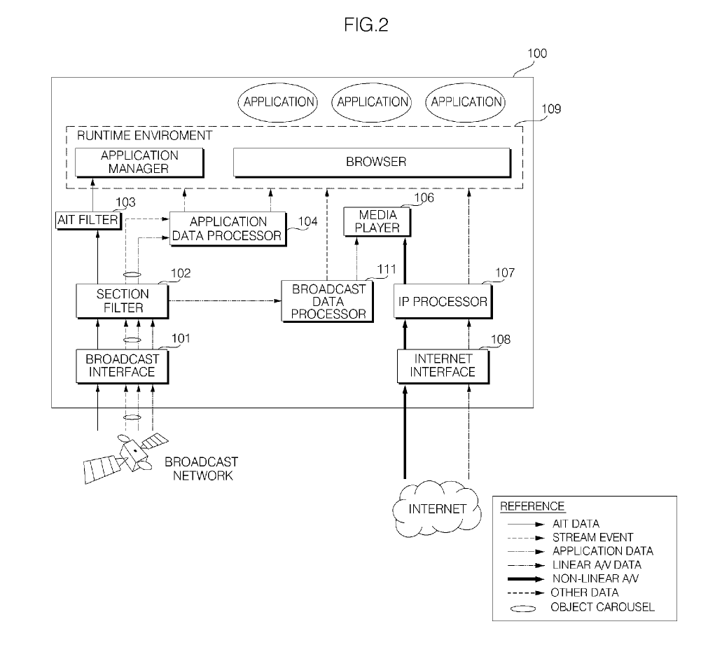

FIG. 2 illustrates the overall configuration of a broadcasting system including an image display apparatus according to another embodiment of the present invention.

Referring to FIG. 2, the image display apparatus 100 according to another embodiment of the present invention is connected to a broadcast network and the Internet. The image display apparatus 100 is, for example, a network TV, a smart TV, an HbbTV, etc.

The image display apparatus 100 includes, for example, a broadcast interface 101, a section filter 102, an Application Information Table (AIT) filter 103, an application data processor 104, a broadcast data processor 111, a media player 106, an IP processor 107, an Internet interface 108, and a runtime module 109.

The image display apparatus 100 receives AIT data, real-time broadcast content, application data, and stream events through the broadcast interface 101. The real-time broadcast content may be referred to as linear Audio/Video (A/V) content.

The section filter 102 performs section filtering on the four types of data received through the broadcast interface 101, and outputs the AIT data to the AIT filter 103, the linear A/V content to the broadcast data processor 111, and the stream events and application data to the application data processor 104.

Meanwhile, the image display apparatus 100 receives non-linear A/V content and application data through the Internet interface 108. The non-linear A/V content may be, for example, a Content On Demand (CoD) application.

The non-linear A/V content and the application data are transmitted to the media player 106 and the runtime module 109, respectively.

The runtime module 109 includes, for example, an application manager and a browser as illustrated in FIG. 2. The application manager controls the life cycle of an interactive application using the AIT data, for example. The browser displays and processes the interactive application.

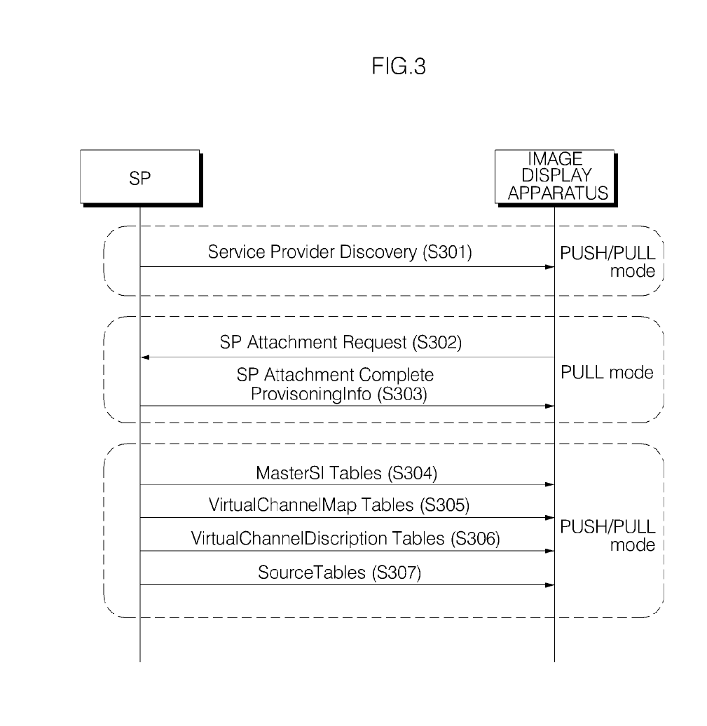

FIG. 3 is a diagram illustrating a signal flow for an operation for attaching to an SP and receiving channel information from the SP in the image display apparatus illustrated in FIG. 1 or 2. Needless to say, the operation illustrated in FIG. 3 is an embodiment, which should not be interpreted as limiting the scope of the present invention.

Referring to FIG. 3, an SP performs an SP Discovery operation (S301) and the image display apparatus transmits a Service Provider Attachment Request signal to the SP (S302). Upon completion of attachment to the SP, the image display apparatus receives provisioning information from the SP (S303). Further, the image display apparatus receives Master System Information (SI) Tables, Virtual Channel Map Tables, Virtual Channel Description Tables, and Source Tables from the SP (S304 to S307).

More specifically, SP Discovery is a process by which SPs that provide IPTV services search for Service Discovery (SD) servers having information about the offerings of the SPs.

In order to receive information about the SD servers, an SD server address list can be detected, for example, using three methods, specifically use of an address preset in the image display apparatus or an address manually set by a user, Dynamic Host Configuration Protocol (DHCP)-based SP Discovery, and Domain Name System Service (DNS SRV)-based SP Discovery. The image display apparatus accesses a specific SD server using the SD server address list obtained through one of the above three methods and receives a SP Discovery record from the specific SD server. The Service Provider Discovery record includes information needed to perform Service Discovery on an SP basis. The image display apparatus then starts a Service Discovery operation using the SP Discovery record. These operations can be performed in a push mode or a pull mode.

The image display apparatus accesses an SP attachment server specified by an SP attachment locator included in the SP Discovery record and performs a registration procedure (or a service attachment procedure).

Further, after accessing an authentication service server of an SP specified by an SP authentication locator and performing an authentication procedure, the image display apparatus may perform a service authentication procedure.

After service attachment is successfully performed, a server may transmit data in the form of a provision information table to the image display apparatus.

During service attachment, the image display apparatus may include an Identifier (ID) and location information thereof in data and transmit the data to the service attachment server. Thus the service attachment server may specify a service that the image display apparatus has subscribed to based on the ID and location information. In addition, the service attachment server provides, in the form of a provisioning information table, address information from which the image display apparatus can obtain Service Information (SI). The address information corresponds to access information about a Master SI Table. This method facilitates provision of a customized service to each subscriber.

The SI is divided into a Master SI Table record for managing access information and version information about a Virtual Channel Map, a Virtual Channel Map Table for providing a list of services in the form of a package, a Virtual Channel Description Table that contains details of each channel, and a Source Table that contains access information about actual services.

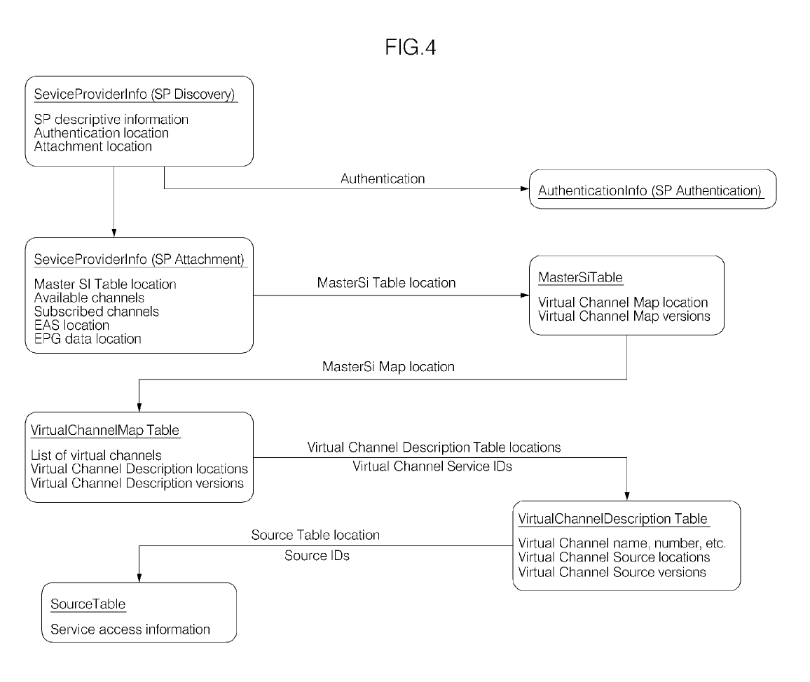

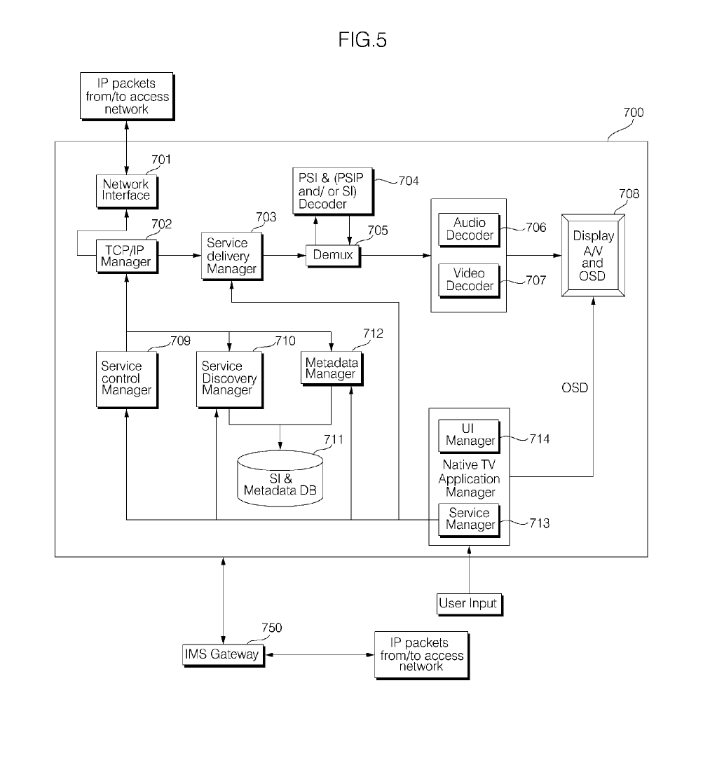

FIG. 4 is a detailed diagram of FIG. 3, illustrating a relationship among data in the SI.

Referring to FIG. 4, a Master SI Table contains information about the location and version of each Virtual Channel MAP.

Each Virtual Channel MAP is identified by its Virtual Channel MAP identifier. VirtualChannelMAPVersion specifies the version number of the Virtual Channel MAP. If any of the tables connected to the Master SI Table in the arrowed direction is modified, the versions of the modified table and overlying tables thereof (up to the Master SI Table) are incremented. Accordingly, a change in any of the SI tables can be readily identified by monitoring the Master SI Table.

For example, when the Source Table is changed, the version of the Source Table is incremented and the version of the Virtual Channel Description Table that references the Source Table is also incremented. In conclusion, a change in any lower table leads to a change in its higher tables and, eventually, a change in the Master SI Table.

One Master SI Table may exist for each SP. However, in the case where service configurations differ for regions or subscribers (or subscriber groups), an SP may have a plurality of Master SI Tables in order to provide a customized service on a region, subscriber or subscriber group basis. Thus it is possible to provide a customized service to a subscriber according to a region in which the subscriber is located and subscriber information regarding the subscriber.

A Virtual Channel Map Table may contain a list of one or more virtual channels. A Virtual Channel Map includes not details of the channels but information about the locations of the details of the channels. In the Virtual Channel Map Table, VirtualChannelDescriptionLocation specifies the location of a Virtual Channel Description Table that provides virtual channel descriptions.

The Virtual Channel Description Table contains the details of the virtual channels. The Virtual Channel Description Table can be accessed using VirtualChannelDescriptionLocation of the Virtual Channel Map Table.

A Source Table provides information necessary to access actual services (e.g. IP addresses, ports, AV Codecs, transmission protocols, etc.) on a service basis.

The above-described Master SI Table, the Virtual Channel Map Table, the Virtual Channel Description Table and the Source Table are delivered in four logically separate flows, in a push mode or a pull mode. For version management, the Master SI Table may be multicast and thus a version change can be monitored by receiving a multicast stream of the Master SI Table.

FIG. 5 is a detailed block diagram of the image display apparatus illustrated in FIG. 1 or 2 according to an embodiment of the present invention. The structure of the image display apparatus in FIG. 5 is purely exemplary and should not be interpreted as limiting the scope of the present invention.

Referring to FIG. 5, an image display apparatus 700 includes a network interface 701, a Transmission Control Protocol/Internet Protocol (TCP/IP) manager 702, a service delivery manager 703, a Demultiplexer (DEMUX) 705, a Program Specific Information (PSI) & (Program and System Information Protocol (PSIP) and/or SI) decoder 704, a display A/V and On Screen Display (OSD) module 708, a service control manager 709, a service discovery manager 710, a metadata manager 712, an SI & metadata DataBase (DB) 711, a User Interface (UI) manager 714, and a service manager 713.

The network interface 701 transmits packets to and receives packets from a network. Specifically, the network interface 701 receives services and content from an SP over the network.

The TCP/IP manager 702 is involved in packet reception and transmission of the image display apparatus 700, that is, packet delivery from a source to a destination. The TCP/IP manager 702 classifies received packets according to appropriate protocols and outputs the classified packets to the service delivery manager 705, the service discovery manager 710, the service control manager 709, and the metadata manager 712.

The service delivery manager 703 controls received service data. For example, when controlling real-time streaming data, the service delivery manager 703 may use the Real-time Transport Protocol/Real-time Transport Control Protocol (RTP/RTCP). If real-time streaming data is transmitted over RTP/RTCP, the service delivery manager 703 parses the received real-time streaming data using RTP and outputs the parsed real-time streaming data to the DEMUX 705 or stores the parsed real-time streaming data in the SI & metadata DB 711 under the control of the service manager 713. In addition, the service delivery manager 703 feeds back network reception information to a server that provides the real-time streaming data service using RTCP.

The DEMUX 705 demultiplexes a received packet into audio data, video data and PSI data and outputs the audio data, video data and PSI data to the audio decoder 706, the video decoder 707, and the PSI & (PSIP and/or SI) decoder 704, respectively.

The PSI & (PSIP and/or SI) decoder 704 decodes SI such as PSI. More specifically, the PSI & (PSIP and/or SI) decoder 704 decodes PSI sections, PSIP sections or SI sections received from the DEMUX 705.

The PSI & (PSIP and/or SI) decoder 704 constructs an SI DB by decoding the received sections and stores the SI DB in the SI & metadata DB 711.

The audio decoder 706 and the video decoder 707 decode the audio data and the video data received from the DEMUX 705 and output the decoded audio and video data to a user through the display AN and OSD module 708.

The UI manager 714 and the service manager 713 manage the overall state of the image display apparatus 700, provide UIs, and manage other managers.

The UI manager 714 provides a Graphical User Interface (GUI) in the form of an OSD and performs a reception operation corresponding to a key input received from the user. For example, upon receipt of a key input signal regarding channel selection from the user, the UI manager 714 transmits the key input signal to the service manager 713.

The service manager 713 controls managers associated with services, such as the service delivery manager 703, the service discovery manager 710, the service control manager 709, and the metadata manager 712.

The service manager 713 also makes a channel map and selects a channel using the channel map according to the key input signal received from the UI manager 714. The service manager 713 sets the audio/video Packet ID (PID) of the selected channel based on SI about the channel received from the PSI & (PSIP and/or SI) decoder 704.

The service discovery manager 710 provides information necessary to select an SP that provides a service. Upon receipt of a channel selection signal from the service manager 713, the service discovery manager 710 detects a service based on the channel selection signal.

The service control manager 709 takes charge of selecting and control services. For example, if a user selects live broadcasting, like a conventional broadcasting service, the service control manager selects and controls the service using Internet Group Management Protocol (IGMP) or Real-Time Streaming Protocol (RTSP). If the user selects Video on Demand (VoD), the service control manager 709 selects and controls the service. RTSP supports trick mode for real-time streaming. Further, the service control manager 709 may initialize and manage a session through an IP Multimedia Control (IMC) gateway using IP Multimedia Subsystem (IMS) and Session Initiation Protocol (SIP). The protocols are given by way of example and thus other protocols are also applicable according to other embodiments.

The metadata manager 712 manages metadata related to services and stores the metadata in the SI & metadata DB 711.

The SI & metadata DB 711 stores the SI decoded by the PSI & (PSIP and/or SI) decoder 704, the metadata managed by the metadata manager 712, and the information required to select an SP, received from the service discovery manager 710. The SI & metadata DB 711 may store setup data for the system.

The SI & metadata DB 711 may be constructed in a Non-Volatile RAM (NVRAM) or a flash memory.

An IMS gateway 705 is a gateway equipped with functions needed to access IMS-based IPTV services.

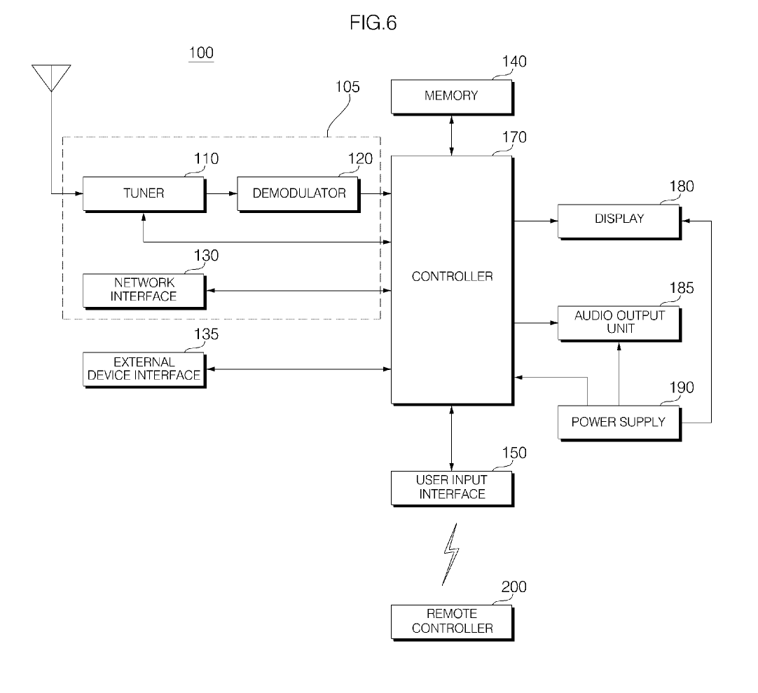

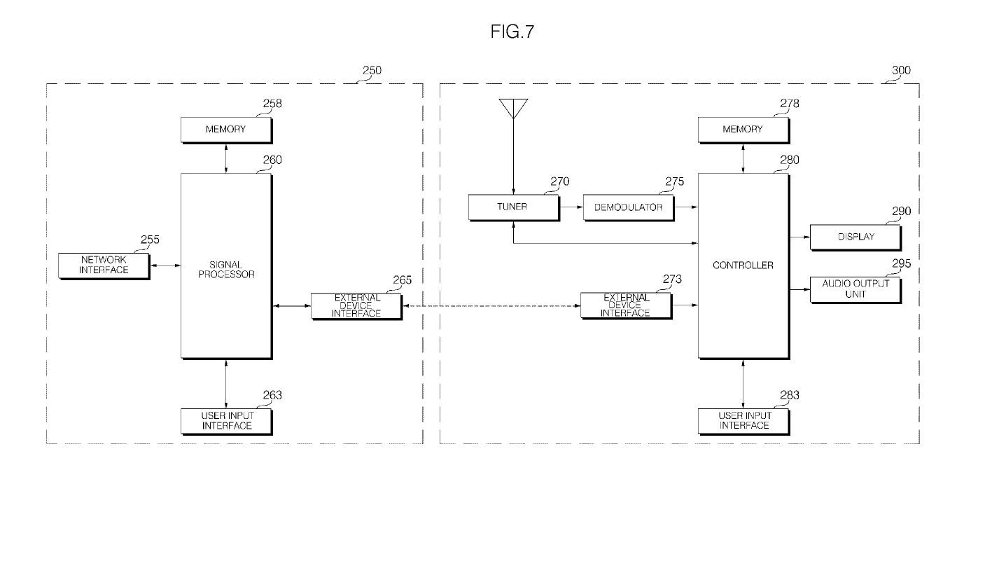

FIG. 6 is a detailed block diagram of the image display apparatus illustrated in FIG. 1 or 2 according to another embodiment of the present invention.

Referring to FIG. 6, an image display apparatus 100 according to another embodiment of the present invention includes a broadcasting receiver 105, an external device interface 135, a memory 140, a user input interface 150, a controller 170, a display 180, an audio output unit 185, a power supply 190, and a camera module. The broadcasting receiver 105 may include a tuner 110, a demodulator 120 and a network interface 130. As needed, the broadcasting receiver 105 may be configured so as to include only the tuner 110 and the demodulator 120 or only the network interface 130.

The tuner 110 selects a Radio Frequency (RF) broadcast signal corresponding to a channel selected by a user from among a plurality of RF broadcast signals received through an antenna and downconverts the selected RF broadcast signal into a digital Intermediate Frequency (IF) signal or an analog baseband A/V signal.

More specifically, if the selected RF broadcast signal is a digital broadcast signal, the tuner 110 downconverts the selected RF broadcast signal into a digital IF signal DIF. On the other hand, if the selected RF broadcast signal is an analog broadcast signal, the tuner 110 downconverts the selected RF broadcast signal into an analog baseband A/V signal, CVBS/SIF. That is, the tuner 110 may be a hybrid tuner capable of processing not only digital broadcast signals but also analog broadcast signals. The analog baseband A/V signal CVBS/SIF may be directly input to the controller 170.

The tuner 110 may be capable of receiving RF broadcast signals from an Advanced Television Systems Committee (ATSC) single-carrier system or from a Digital Video Broadcasting (DVB) multi-carrier system.

The tuner 110 may sequentially select a number of RF broadcast signals corresponding to all broadcast channels previously stored in the image display apparatus 100 by a channel add function from a plurality of RF signals received through the antenna and may downconvert the selected RF broadcast signals into IF signals or baseband A/V signals.

The demodulator 120 receives the digital IF signal DIF from the tuner 110 and demodulates the digital IF signal DIF.

For example, if the digital IF signal DIF is an ATSC signal, the demodulator 120 may perform 8-Vestigal SideBand (VSB) demodulation on the digital IF signal DIF. The demodulator 120 may also perform channel decoding. For channel decoding, the demodulator 120 may include a Trellis decoder, a de-interleaver and a Reed-Solomon decoder so as to perform Trellis decoding, de-interleaving and Reed-Solomon decoding.

For example, if the digital IF signal DIF is a DVB signal, the demodulator 120 performs Coded Orthogonal Frequency Division Multiple Access (COFDMA) demodulation upon the digital IF signal DIF. The demodulator 120 may also perform channel decoding. For channel decoding, the demodulator 120 may include a convolution decoder, a de-interleaver, and a Reed-Solomon decoder so as to perform convolution decoding, de-interleaving, and Reed-Solomon decoding.

The demodulator 120 may perform demodulation and channel decoding on the digital IF signal DIF, thereby obtaining a stream signal TS. The stream signal TS may be a signal in which a video signal, an audio signal and a data signal are multiplexed. For example, the stream signal TS may be an MPEG-2 TS in which an MPEG-2 video signal and a Dolby AC-3 audio signal are multiplexed. An MPEG-2 TS may include a 4-byte header and a 184-byte payload.

In order to properly handle not only ATSC signals but also DVB signals, the demodulator 120 may include an ATSC demodulator and a DVB demodulator.

The stream signal TS may be input to the controller 170 and thus subjected to demultiplexing and A/V signal processing. The processed video and audio signals are output to the display 180 and the audio output unit 185, respectively.

The external device interface 135 may serve as an interface between an external device and the image display apparatus 100. For interfacing, the external device interface 135 may include an A/V Input/Output (I/O) unit and/or a wireless communication module.

The external device interface 135 may be connected to an external device such as a Digital Versatile Disk (DVD) player, a Blu-ray player, a game console, a camera, a camcorder, or a computer (e.g., a laptop computer), wirelessly or by wire. Then, the external device interface 135 externally receives video, audio, and/or data signals from the external device and transmits the received input signals to the controller 170. In addition, the external device interface 135 may output video, audio, and data signals processed by the controller 170 to the external device. In order to receive or transmit audio, video and data signals from or to the external device, the external device interface 135 includes the A/V I/O unit and/or the wireless communication module.

The A/V I/O unit of the external device interface 135 may include a Universal Serial Bus (USB) port, a Composite Video Banking Sync (CVBS) port, a Component port, a Super-video (S-video) (analog) port, a Digital Visual Interface (DVI) port, a High-Definition Multimedia Interface (HDMI) port, a Red-Green-Blue (RGB) port, and a D-sub port.

The wireless communication module of the external device interface 135 may perform short-range wireless communication with other electronic devices. For short-range wireless communication, the wireless communication module may use Bluetooth, Radio-Frequency IDentification (RFID), Infrared Data Association (IrDA), Ultra WideBand (UWB), ZigBee, and Digital Living Network Alliance (DLNA).

The external device interface 135 may be connected to various set-top boxes through at least one of the above-described ports and may thus receive data from or transmit data to the various set-top boxes.

The external device interface 135 may receive applications or an application list from an adjacent external device and provide the applications or the application list to the controller 170 or the memory 140.

The network interface 130 serves as an interface between the image display apparatus 100 and a wired/wireless network such as the Internet. The network interface 130 may include an Ethernet port for connection to a wired network. The wireless communication module of the external signal I/O unit 128 may wirelessly access the Internet. For connection to wireless networks, the network interface 130 may use Wireless Local Area Network (WLAN) (i.e., Wi-Fi), Wireless Broadband (WiBro), World Interoperability for Microwave Access (WiMax), and High Speed Downlink Packet Access (HSDPA).

The network interface 130 may transmit data to or receive data from another user or electronic device over a connected network or another network linked to the connected network. Especially, the network interface 130 may transmit data stored in the image display apparatus 100 to a user or electronic device selected from among users or electronic devices pre-registered with the image display apparatus 100.

The network interface 130 may access a specific Web page over a connected network or another network linked to the connected network. That is, the network interface 130 may access a specific Web page over a network and transmit or receive data to or from a server. Additionally, the network interface 130 may receive content or data from a CP or an NP. Specifically, the network interface 130 may receive content such as movies, advertisements, games, VoD files, and broadcast signals, and information related to the content from a CP or an NP. Also, the network interface 130 may receive update information about firmware and update files of the firmware from the NP. The network interface 130 may transmit data over the Internet or to the CP or the NP.

The network interface 130 may selectively receive a desired application among open applications over a network.

In an embodiment of the present invention, when a game application is executed in the image display apparatus 100, the network interface 130 may transmit data to or receive data from a user terminal connected to the image display apparatus 100 through a network. In addition, the network interface 130 may transmit specific data to or receive specific data from a server that records game scores.

The memory 140 may store various programs necessary for the controller 170 to process and control signals, and may also store processed video, audio and data signals.

The memory 140 may temporarily store a video, audio and/or data signal received from the external device interface 135 or the network interface 130. The memory 140 may store information about broadcast channels by the channel-add function.

The memory 140 may store applications or a list of applications received from the external device interface 135 or the network interface 130.

The memory 140 may store a variety of platforms which will be described later.

In an embodiment of the present invention, when the image display apparatus 100 executes a game application, the memory 140 may store user-specific information and game play information about a user terminal used as a game controller.

The memory 140 may include, for example, at least one of a flash memory-type storage medium, a hard disk-type storage medium, a multimedia card micro-type storage medium, a card-type memory (e.g. a Secure Digital (SD) or eXtreme Digital (XD) memory), a Random Access Memory (RAM), or a Read-Only Memory (ROM) such as an Electrically Erasable and Programmable Read Only Memory. The image display apparatus 100 may reproduce content stored in the memory 140 (e.g. video files, still image files, music files, text files, and application files) to the user.

While the memory 140 is shown in FIG. 6 as configured separately from the controller 170, to which the present invention is not limited, the memory 140 may be incorporated into the controller 170, for example.

The user input interface 150 transmits a signal received from the user to the controller 170 or transmits a signal received from the controller 170 to the user.

For example, the user input interface 150 may receive various user input signals such as a power-on/off signal, a channel selection signal, and a screen setting signal from a remote controller 200 or may transmit a signal received from the controller 170 to the remote controller 200, according to various communication schemes, for example, RF communication and IR communication.

For example, the user input interface 150 may provide the controller 170 with user input signals or control signals received from local keys, such as inputs of a power key, a channel key, and a volume key, and setting values.

Also, the user input interface 150 may transmit a control signal received from a sensor unit for sensing a user gesture to the controller 170 or transmit a signal received from the controller 170 to the sensor unit. The sensor unit may include a touch sensor, a voice sensor, a position sensor, a motion sensor, etc.

The controller 170 may demultiplex the stream signal TS received from the tuner 110, the demodulator 120, or the external device interface 135 into a number of signals and process the demultiplexed signals into audio and video data.

The video signal processed by the controller 170 may be displayed as an image on the display 180. The video signal processed by the controller 170 may also be transmitted to an external output device through the external device interface 135.

The audio signal processed by the controller 170 may be output to the audio output unit 185. Also, the audio signal processed by the controller 170 may be transmitted to the external output device through the external device interface 135.

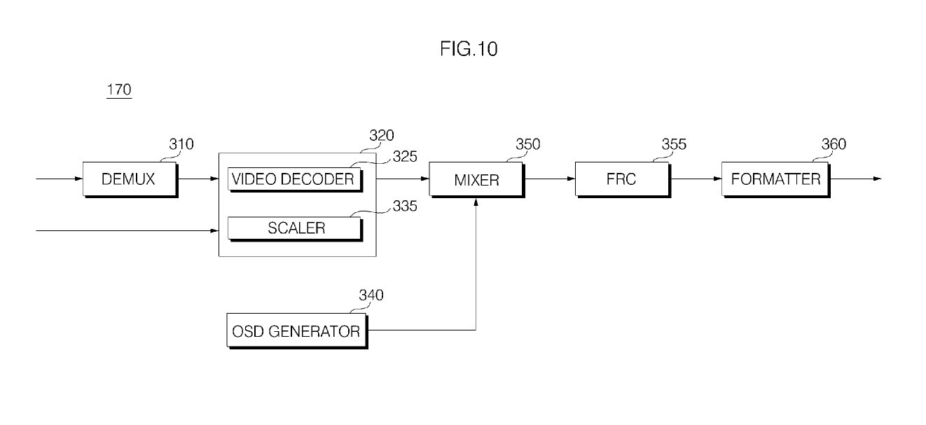

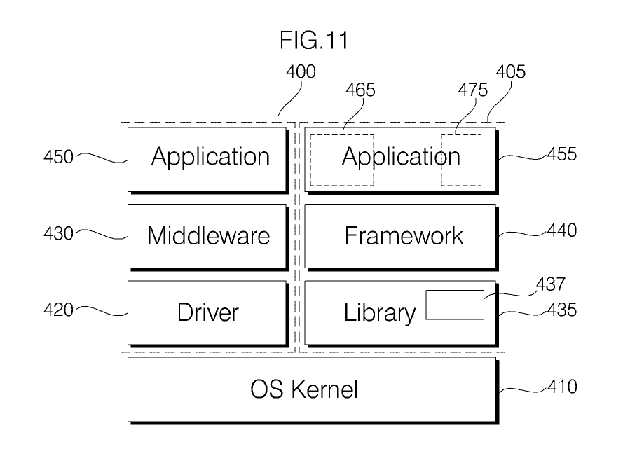

While not shown in FIG. 6, the controller 170 may include a DEMUX and a video processor, which will be described later with reference to FIG. 10.

In addition, the controller 170 may provide overall control to the image display apparatus 100. For example, the controller 170 may control the tuner 110 to select an RF broadcast signal corresponding to a user-selected channel or a pre-stored channel.

The controller 170 may control the image display apparatus 100 according to a user command received through the user input interface 150 or according to an internal program. Especially the controller 170 may access a network and download an application or application list selected by the user to the image display apparatus 100 over the network.

For example, the controller 170 controls the tuner 110 to receive a channel selected according to a specific channel selection command received through the user input interface 150 and processes a video, audio and/or data signal of the selected channel. The controller 170 outputs the processed video or audio signal along with information about the user-selected channel to the display 180 or the audio output unit 185.

In another example, the controller 170 outputs a video or audio signal received from an external device such as a camera or a camcorder through the external device interface 135 to the display 180 or the audio output unit 185 according to an external device video playback command received through the external device interface 150.

The controller 170 may control the display 180 to display images. For instance, the controller 170 may control the display 180 to display a broadcast image received from the timer 110, an external input image received through the external device interface 135, an image received through the network interface 130, or an image stored in the memory 140. The image displayed on the display 180 may be a Two-Dimensional (2D) or Three-Dimensional (3D) still image or moving picture.

The controller 170 may control content playback. The content may include any content stored in the image display apparatus 100, received broadcast content, and external input content. The content includes at least one of a broadcast image, an external input image, an audio file, a still image, a Web page, or a text file.

Upon receipt of a go-to-home input, the controller 170 may control display of the home screen on the display 180 in an embodiment of the present invention.

The home screen may include a plurality of card objects classified according to content sources. The card objects may include at least one of a card object representing a thumbnail list of broadcast channels, a card object representing a broadcast program guide, a card object representing a program reservation list or a program recording list, or a card object representing a media list of a device connected to the image display apparatus 100. The card objects may further include at least one of a card object representing a list of connected external devices or a card object representing a call-associated list.

The home screen may further include an application menu with at least one application that can be executed.

Upon receipt of a card object move input, the controller 170 may control movement of a card object corresponding to the card object move input on the display 180, or if the card object is not displayed on the display 180, the controller 170 may control display of the card object on the display 180.

When a card object is selected from among the card objects on the home screen, the controller 170 may control display of an image corresponding to the selected card object on the display 180.

The controller 170 may control display of an input broadcast image and an object representing information about the broadcast image in a card object representing broadcast images. The broadcast image may be fixed in size through lock setting.

The controller 170 may control display of a set-up object for at least one of image setting, audio setting, screen setting, reservation setting, setting of a pointer of the remote controller, or network setting on the home screen.

The controller 170 may control display of a log-in object, a help object, or an exit object on a part of the home screen.

The controller 170 may control display of an object representing the total number of available card objects or the number of card objects displayed on the display 180 among all card objects, on a part of the home screen.

If one of the card objects displayed on the display 180 is selected, the controller 170 may fullscreen the selected card object to cover the entirety of the display 180.

Upon receipt of an incoming call at a connected external device or the image display apparatus 100, the controller 170 may control focusing-on or shift of a call-related card object among the plurality of card objects.

If an application view menu item is selected, the controller 170 may control display of applications or a list of applications that are available in the image display apparatus or downloadable from an external network.

The controller 170 may control installation and execution of an application downloaded from the external network along with various UIs. Also, the controller 170 may control display of an image related to the executed application on the display 180, upon user selection.

In an embodiment of the present invention, when the image display apparatus 100 provides a game application, the controller 170 may control assignment of player IDs to specific user terminals, creation of game play information by executing the game application, transmission of the game play information to the user terminals through the network interface 130, and reception of the game play information at the user terminals.

The controller 170 may control detection of user terminals connected to the image display apparatus 100 over a network through the network interface 130, display of a list of the detected user terminals on the display 180 and reception of a selection signal indicating a user terminal selected for use as a user controller from among the listed user terminals through the user input interface 150.

The controller 170 may control output of a game play screen of the game application, inclusive of player information about each user terminal and game play information, through the display 180.

The controller 170 may determine the specific signal received from a user terminal through the network interface 130 as game play information and thus control the game play information to be reflected in the game application in progress.

The controller 170 may control transmission of the game play information about the game application to a specific server connected to the image display apparatus 100 over a network through the network interface 130.

As another embodiment, upon receipt of information about a change in the game play information from the server through the network interface 130, the controller 170 may control output of a notification message in a predetermined area of the display 180.

The image display apparatus 100 may further include a channel browsing processor for generating thumbnail images corresponding to channel signals or external input signals.

The channel browsing processor may extract some of the video frames of each of stream signals TS received from the demodulator 120 or stream signals received from the external device interface 135 and display the extracted video frames on the display 180 as thumbnail images. The thumbnail images may be directly output to the controller 170 or may be output after being encoded. Also, it is possible to encode the thumbnail images into a stream and output the stream to the controller 170. The controller 170 may display a thumbnail list including a plurality of received thumbnail images on the display 180. The thumbnail images may be updated sequentially or simultaneously in the thumbnail list. Therefore, the user can readily identify the content of broadcast programs received through a plurality of channels.

The display 180 may convert a processed video signal, a processed data signal, and an OSD signal received from the controller 170 or a video signal and a data signal received from the external device interface 135 into RGB signals, thereby generating driving signals.

The display 180 may be various types of displays such as a Plasma Display Panel (PDP), a Liquid Crystal Display (LCD), an Organic Light-Emitting Diode (OLED) display, a flexible display, and a 3D display.

The display 180 may also be a touch screen that can be used not only as an output device but also as an input device.

The audio output unit 185 may receive a processed audio signal (e.g., a stereo signal, a 3.1-channel signal or a 5.1-channel signal) from the controller 170 and output the received audio signal as sound. The audio output unit 185 may employ various speaker configurations.

To sense a user gesture, the image display apparatus 100 may further include the sensor unit that has at least one of a touch sensor, a voice sensor, a position sensor, and a motion sensor, as stated before. A signal sensed by the sensor unit may be output to the controller 170 through the user input interface 150.

The image display apparatus 100 may further include the camera unit for capturing images of a user. Image information captured by the camera unit may be input to the controller 170.

The controller 170 may sense a user gesture from an image captured by the camera unit or a signal sensed by the sensor unit, or by combining the captured image and the sensed signal.

The power supply 190 supplies power to the image display apparatus 100. Particularly, the power supply 190 may supply power to the controller 170, the display 180, and the audio output unit 185, which may be implemented as a System On Chip (SOC).

For supplying power, the power supply 190 may include a converter for converting Alternating Current (AC) into Direct Current (DC). If the display 180 is configured with, for example, a liquid crystal panel having a plurality of backlight lamps, the power supply 190 may further include an inverter capable of performing Pulse Width Modulation (PWM) for luminance change or dimming driving.

The remote controller 200 transmits a user input to the user input interface 150. For transmission of user input, the remote controller 200 may use various communication techniques such as Bluetooth, RF communication, IR communication, UWB and ZigBee.

In addition, the remote controller 200 may receive a video signal, an audio signal or a data signal from the user input interface 150 and output the received signals visually, audibly or as vibrations.

The above-described image display apparatus 100 may be a fixed digital broadcast receiver capable of receiving at least one of ATSC (8-VSB) broadcast programs, DVB-T (COFDM) broadcast programs, and ISDB-T (BST-OFDM) broadcast programs.

The block diagram of the image display apparatus 100 illustrated in FIG. 6 is purely exemplary. Depending upon the specifications of the image display apparatus 100 in actual implementation, the components of the image display apparatus 100 may be combined or omitted or new components may be added. That is, two or more components are incorporated into one component or one component may be configured as separate components, as needed. In addition, the function of each block is described for the purpose of describing the embodiment of the present invention and thus specific operations or devices should not be construed as limiting the scope and spirit of the present invention.

Unlike the configuration illustrated in FIG. 6, the image display apparatus 100 may be configured so as to receive and playback video content through the network interface 130 or the external device interface 135, without the tuner 100 and the demodulator 120.

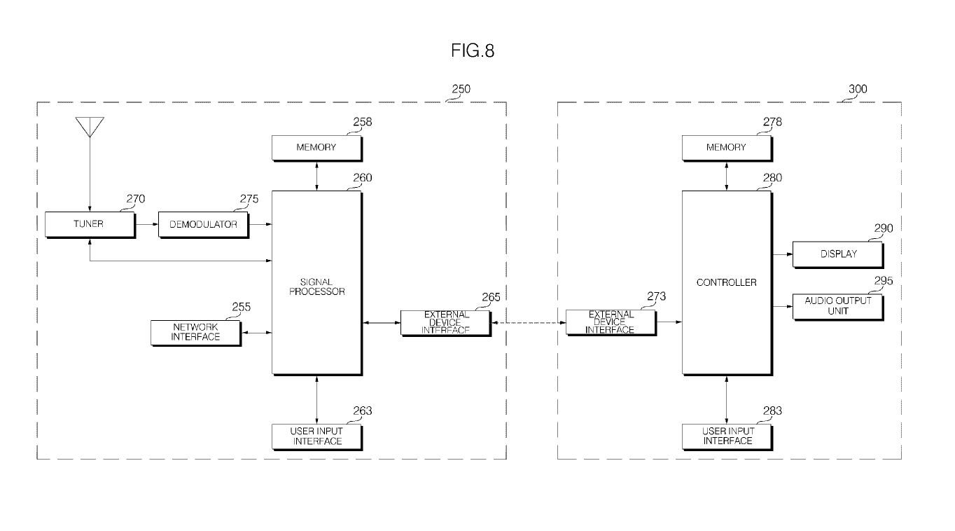

The image display apparatus 100 is an example of image signal processing apparatus that processes a stored image or an input image. Other examples of the image signal processing apparatus include a set-top box without the display 180 or the audio output unit 185, a DVD player, a Blu-ray player, a game console, and a computer. The set-top box will be described later with reference to FIGS. 7 and 8.

FIGS. 7 and 8 are block diagrams illustrating either of the image display apparatuses separately as a set-top box and a display device according to embodiments of the present invention.

Referring to FIG. 7, a set-top box 250 and a display device 300 may transmit or receive data wirelessly or by wire.

The set-top box 250 may include a network interface 255, a memory 258, a signal processor 260, a user input interface 263, and an external device interface 265.

The network interface 255 serves as an interface between the set-top box 250 and a wired/wireless network such as the Internet. The network interface 255 may transmit data to or receive data from another user or another electronic device over a connected network or over another network linked to the connected network.

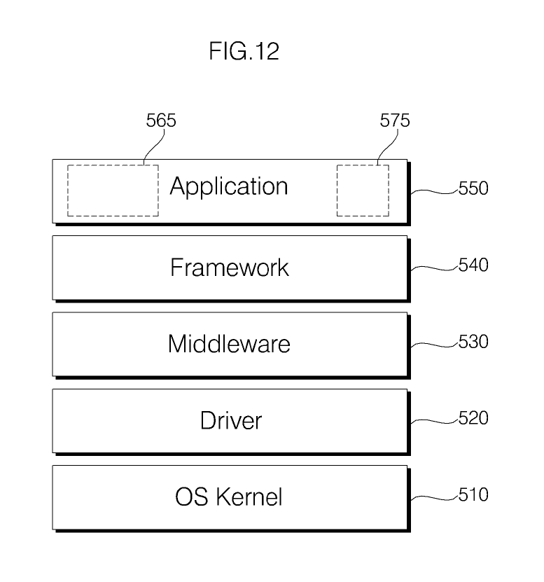

The memory 258 may store programs necessary for the signal processor 260 to process and control signals and temporarily store a video, audio and/or data signal received from the external device interface 265 or the network interface 255. The memory 258 may also store platforms illustrated in FIGS. 11 and 12, as described later.

The signal processor 260 processes an input signal. For example, the signal processor 260 may demultiplex or decode an input video or audio signal. For signal processing, the signal processor 260 may include a video decoder or an audio decoder. The processed video or audio signal may be transmitted to the display device 300 through the external device interface 265.

The user input interface 263 transmits a signal received from the user to the signal processor 260 or a signal received from the signal processor 260 to the user. For example, the user input interface 263 may receive various control signals such as a power on/off signal, an operation input signal, and a setting input signal through a local key or the remote controller 200 and output the control signals to the signal processor 260.

The external device interface 265 serves as an interface between the set-top box 250 and an external device that is connected wirelessly or by wire, particularly the display device 300, for signal transmission or reception. The external device interface 265 may also interface with an external device such as a game console, a camera, a camcorder, and a computer (e.g. a laptop computer), for data transmission or reception.

The set-top box 250 may further include a media input unit for media playback. The media input unit may be a Blu-ray input unit, for example. That is, the set-top box 250 may include a Blu-ray player. After signal processing such as demultiplexing or decoding in the signal processor 260, a media signal from a Blu-ray disk may be transmitted to the display device 300 through the external device interface 265 so as to be displayed on the display device 300.

The display device 300 may include a tuner 270, an external device interface 273, a demodulator 275, a memory 278, a controller 280, a user input interface 283, a display 290, and an audio output unit 295.

The tuner 270, the demodulator 275, the memory 278, the controller 280, the user input interface 283, the display 290, and the audio output unit 295 are identical respectively to the tuner 110, the demodulator 120, the memory 140, the controller 170, the user input interface 150, the display 180, and the audio output unit 185 illustrated in FIG. 6 and thus a description thereof is not provided herein.

The external device interface 273 serves as an interface between the display device 300 and a wireless or wired external device, particularly the set-top box 250, for data transmission or reception.

Hence, a video signal or an audio signal received through the set-top box 250 is output through the display 290 or the audio output unit 295 through the controller 280.

Referring to FIG. 8, the configuration of the set-top box 250 and the display device 300 illustrated in FIG. 8 is similar to that of the set-top box 250 and the display device 300 illustrated in FIG. 7, except that the tuner 270 and the demodulator 275 reside in the set-top box 250, not in the display device 300. Thus the following description is given focusing on such difference.

The signal processor 260 may process a broadcast signal received through the tuner 270 and the demodulator 275. The user input interface 263 may receive a channel selection input, a channel store input, etc.

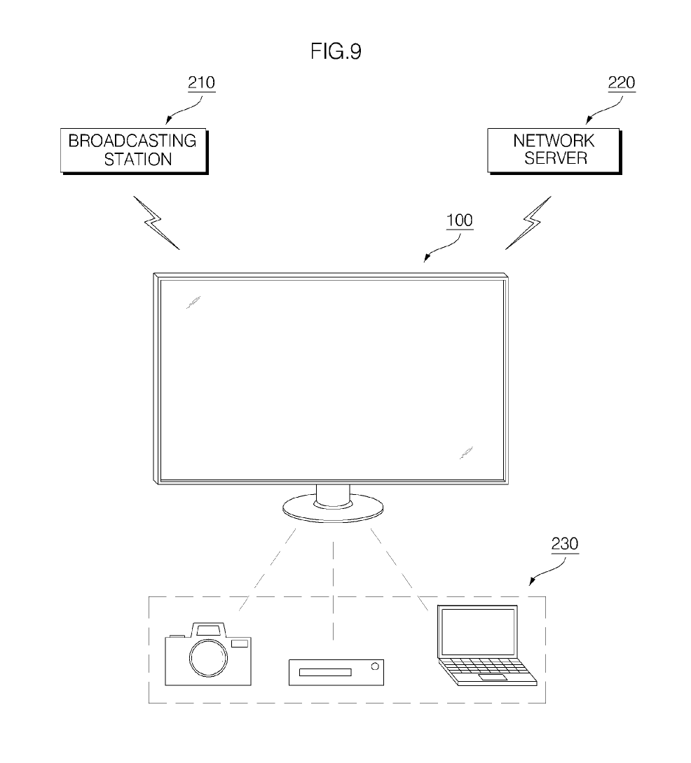

FIG. 9 illustrates an operation for communicating with third devices in either of the image display apparatuses according to an embodiment of the present invention. The image display apparatus illustrated in FIG. 9 may be one of the afore-described image display apparatuses according to the embodiments of the present invention.

Referring to FIG. 9, the image display apparatus 100 may communicate with a broadcasting station 210, a network server 220, or an external device 230.

The image display apparatus 100 may receive a broadcast signal including a video signal from the broadcasting station 210. The image display apparatus 100 may process the audio and video signals of the broadcast signal or the data signal of the broadcast signal, suitably for transmission from the image display apparatus 100. The image display apparatus 100 may output images or sound based on the processed video or audio signal.

Meanwhile, the image display apparatus 100 may communicate with the network server 220. The network server 200 is capable of transmitting signals to and receiving signals from the image display apparatus 100 over a network. For example, the network server 220 may be a portable terminal that can be connected to the image display apparatus 100 through a wired or wireless base station. In addition, the network server 200 may provide content to the image display apparatus 100 over the Internet. A CP may provide content to the image display apparatus 100 through the network server 220.

The image display apparatus 100 may communicate with the external device 230. The external device 230 can transmit and receive signals directly to and from the image display apparatus 100 wirelessly or by wire. For instance, the external device 230 may be a media memory device or a player. That is, the external device 230 may be any of a camera, a DVD player, a Blu-ray player, a PC, etc.

The broadcasting station 210, the network server 220 or the external device 230 may transmit a signal including a video signal to the image display apparatus 100. The image display apparatus 100 may display an image based on the video signal included in the received signal. Also, the image display apparatus 100 may transmit a signal received from the broadcasting station 210 or the network server 220 to the external device 230 and may transmit a signal received from the external device 230 to the broadcasting station 210 or the network server 220. That is, the image display apparatus 100 may transmit content included in signals received from the broadcasting station 210, the network server 220, and the external device 230, as well as playback the content immediately.

FIG. 10 is a block diagram of an example of the controller illustrated in FIG. 6.

Referring to FIG. 10, the controller 170 may include a DEMUX 310, a video processor 320, an OSD generator 340, a mixer 350, a Frame Rate Converter (FRC) 355, and a formatter 360 according to an embodiment of the present invention. The controller 170 may further include an audio processor and a data processor.

The DEMUX 310 demultiplexes an input stream. For example, the DEMUX 310 may demultiplex an MPEG-2 TS into a video signal, an audio signal, and a data signal. The input stream signal may be received from the tuner 110, the demodulator 120 or the external device interface 135.

The video processor 320 may process the demultiplexed video signal. For video signal processing, the video processor 320 may include a video decoder 325 and a scaler 335.

The video decoder 325 decodes the demultiplexed video signal and the scaler 335 scales the resolution of the decoded video signal so that the video signal can be displayed on the display 180.

The video decoder 325 may be provided with decoders that operate based on various standards.

If the demultiplexed video signal is, for example, an MPEC-2 encoded video signal, the video signal may be decoded by an MPEC-2 decoder.

On the other hand, if the video signal is an H.264-encoded DMB or DVB-handheld (DVB-H) signal, the video signal may be decoded by an H.264 decoder.

The video signal decoded by the video processor 320 is provided to the mixer 350.

The OSD generator 340 generates an OSD signal autonomously or according to user input. For example, the OSD generator 340 may generate signals by which a variety of information is displayed as images or text on the display 180, according to control signals received from the user input interface 150. The OSD signal may include various data such as a UI, a variety of menu screens, widgets, icons, etc.

For example, the OSD generator 340 may generate a signal by which subtitles are displayed for a broadcast image or Electronic Program Guide (EPG)-based broadcasting information.

The mixer 350 may mix the decoded video signal with the OSD signal and output the mixed signal to the formatter 360. As the decoded broadcast video signal or the external input signal is mixed with the OSD signal, an OSD may be overlaid on the broadcast image or the external input image.

The FRC 355 may change the frame rate of an input image. For example, a frame rate of 60 Hz is converted into a frame rate of 120 or 240 Hz. When the frame rate is to be changed from 60 Hz to 120 Hz, a first frame is inserted between the first frame and a second frame, or a predicted third frame is inserted between the first and second frames. If the frame rate is to be changed from 60 Hz to 240 Hz, three identical frames or three predicted frames are inserted between the first and second frames. It is also possible to maintain the frame rate of the input image without frame rate conversion.

The formatter 360 changes the format of the signal received from the FRC 355 to be suitable for the display 180. For example, the formatter 360 may convert a received signal into an RGB data signal. The RGB signal may be output in the form of a Low Voltage Differential Signal (LVDS) or mini-LVDS.

The audio processor of the controller 170 may process the demultiplexed audio signal. For audio signal processing, the audio processor may have a plurality of decoders.

If the demultiplexed audio signal is a coded audio signal, the audio processor of the controller 170 may decode the audio signal. For example, the demultiplexed audio signal may be decoded by an MPEG-2 decoder, an MPEG-4 decoder, an Advanced Audio Coding (AAC) decoder, or an AC-3 decoder.

The audio processor of the controller 170 may also adjust the bass, treble or volume of the audio signal.

The data processor of the controller 170 may process the data signal obtained by demultiplexing the input stream signal. For example, if the data signal is an encoded signal such as an EPG which includes broadcasting information specifying the start time, end time, etc. of scheduled broadcast TV or radio programs, the controller 170 may decode the data signal. Examples of an EPG include ATSC-Program and System Information Protocol (PSIP) information and DVB-Service Information (SI).

ATSC-PSIP information or DVB-SI may be included in the header of a TS, i.e., a 4-byte header of an MPEG-2 TS.

The block diagram of the controller 170 illustrated in FIG. 10 is an embodiment of the present invention. Depending upon the specifications of the controller 170, the components of the controller 170 may be combined, or omitted. Or new components are added to the controller 170.

FIG. 11 illustrates a platform architecture for either of the image display apparatuses according to an embodiment of the present invention and FIG. 12 illustrates a platform architecture for either of the image display apparatuses according to another embodiment of the present invention.

A platform for either of the image display apparatuses may have OS-based software to implement the above-described various operations according to an embodiment of the present invention.

Referring to FIG. 11, a platform for either of the image display apparatuses is a separate type according to an embodiment of the present invention. The platform may be designed separately as a legacy system platform 400 and a smart system platform 405. An OS kernel 410 may be shared between the legacy system platform 400 and the smart system platform 405.

The legacy system platform 400 may include a stack of a driver 420, middleware 430, and an application layer 450 on the OS kernel 410.

On the other hand, the smart system platform 405 may include a stack of a library 435, a framework 440, and an application layer 455 on the OS kernel 410.

The OS kernel 410 is the core of an operating system. When the image display apparatus is driven, the OS kernel 410 may be responsible for operation of at least one of hardware drivers, security protection for hardware and processors in the image display apparatus, efficient management of system resources, memory management, hardware interfacing by hardware abstraction, multi-processing, or scheduling associated with the multi-processing. Meanwhile, the OS kernel 410 may further perform power management.

The hardware drivers of the OS kernel 410 may include, for example, at least one of a display driver, a Wi-Fi driver, a Bluetooth driver, a USB driver, an audio driver, a power manager, a binder driver, or a memory driver.

Alternatively or additionally, the hardware drivers of the OS kernel 410 may be drivers for hardware devices within the OS kernel 410. The hardware drivers may include a character device driver, a block device driver, and a network device driver. The block device driver may need a buffer for buffering data on a block basis, because data is transmitted on a block basis. The character device driver may not need a buffer since data is transmitted on a basic data unit basis, that is, on a character basis.

The OS kernel 410 may be implemented based on any of various OSs such as UNIX (Linux), Windows, etc. The OS kernel 410 may be a general-purpose open OS kernel which can be implemented in other electronic devices.

The driver 420 is interposed between the OS kernel 410 and the middleware 430. Along with the middleware 430, the driver 420 drives devices for operations of the application layer 450. For example, the driver 420 may include a driver(s) for a microcomputer, a display module, a Graphic Processing Unit (GPU), the FRC, a General-Purpose Input/Output (GPIO) pin, a High-Definition Multimedia Interface (HDMI), a System Decoder (SDEC) or DEMUX, a Video Decoder (VDEC), an Audio Decoder (ADEC), a Personal Video Recorder (PVR), and/or an Inter-Integrated Circuit (12C). These drivers operate in conjunction with the hardware drivers of the OS kernel 410.

In addition, the driver 420 may further include a driver for the remote controller 200, especially a pointing device to be described below. The remote controller driver may reside in the OS kernel 410 or the middleware 430, instead of the driver 420.

The middleware 430 resides between the OS kernel 410 and the application layer 450. The middleware 430 may mediate between different hardware devices or different software programs, for data transmission and reception between the hardware devices or the software programs. Therefore, the middleware 430 can provide standard interfaces, support various environments, and enable interaction between tasks conforming to heterogeneous communication protocols.

Examples of the middleware 430 in the legacy system platform 400 may include Multimedia and Hypermedia information coding Experts Group (MHEG) and Advanced Common Application Platform (ACAP) as data broadcasting-related middleware, PSIP or SI middleware as broadcasting information-related middleware, and DLNA middleware as peripheral device communication-related middleware.

The application layer 450 that runs atop the middleware 430 in the legacy system platform 400 may include, for example, UI applications associated with various menus in the image display apparatus. The application layer 450 may allow editing and updating over a network by user selection. With use of the application layer 450, the user may enter a desired menu among various UIs by manipulating the remote controller 210 while viewing a broadcast program.

The application layer 450 may further include at least one of a TV guide application, a Bluetooth application, a reservation application, a Digital Video Recorder (DVR) application, and a hotkey application.

In the smart system platform 405, the library 435 is positioned between the OS kernel 410 and the framework 440, forming the basis of the framework 440. For example, the library 435 may include Secure Socket Layer (SSL) being a security-related library, WebKit being a Web engine-related library, c library (libc), and Media Framework being a media-related library specifying, for example, a video format and an audio format. The library 435 may be written in C or C++. Also, the library 435 may be exposed to a developer through the framework 440.

The library 435 may include a runtime 437 with a core Java library and a Virtual Machine (VM). The runtime 437 and the library 435 form the basis of the framework 440.

The VM may be a virtual machine that enables concurrent execution of a plurality of instances, that is, multi-tasking. For each application of the application layer 455, a VM may be allocated and executed. For scheduling or interconnection between instances, the binder driver of the OS kernel 410 may operate.

The binder driver and the runtime 437 may connect Java applications to C-based libraries.

The library 435 and the runtime 437 may correspond to the middleware 430 of the legacy system platform 400.

In the smart system platform 405, the framework 440 includes programs on which applications of the application layer 455 are based. The framework 440 is compatible with any application and may allow component reuse, movement or exchange. The framework 440 may include supporting programs and programs for interconnecting different software components. For example, the framework 440 may include an activity manager related to activities of applications, a notification manager, and a CP for abstracting common information between applications. This framework 440 may be written in Java.

The application layer 455 on top of the framework 440 includes a variety of programs that are executed and displayed in the image display apparatus. The application layer 455 may include, for example, a core application that is a suit having at least one solution of e-mail, Short Message Service (SMS), calendar, map, or browser. The application layer 455 may be written in Java.

In the application layer 455, applications may be categorized into user-undeletable applications 465 stored in the image display apparatus 100 that cannot be modified and user-installable or user-deletable applications 475 that are downloaded from an external device or a network and stored in the image display apparatus.

With the applications of the application layer 455, a variety of functions such as Internet telephony, VoD, Web album, Social Networking Service (SNS), Location-Based Service (LBS), map service, Web browsing, and application search may be performed through network access. In addition, other functions such as gaming and schedule management may be performed by the applications.

Referring to FIG. 12, a platform for the image display apparatus according to another embodiment of the present invention is an integrated type. The integrated platform may include an OS kernel 510, a driver 520, middleware 530, a framework 540, and an application layer 550.

Compared to the separate-type platform illustrated in FIG. 11, the integrated-type platform is characterized by the absence of the library 435 and the application layer 550 being an integrated layer. The driver 520 and the framework 540 correspond to the driver 420 and the framework 440 of FIG. 5, respectively.

The library 435 of FIG. 11 may be incorporated into the middleware 530. That is, the middleware 530 may include both the legacy system middleware and the image display system middleware. As described before, the legacy system middleware includes MHEG or ACAP as data broadcasting-related middleware, PSIP or SI middleware as broadcasting information-related middleware, and DLNA middleware as peripheral device communication-related middleware, whereas the image display system middleware includes SSL as a security-related library, WebKit as a Web engine-related library, libc, and Media Framework as a media-related library. The middleware 530 may further include the afore-described runtime.

The application layer 550 may include a menu-related application, a TV guide application, a reservation application, etc. as legacy system applications, and e-mail, SMS, a calendar, a map, and a browser as image display system applications.

In the application layer 550, applications may be categorized into user-undeletable applications 565 that are stored in the image display apparatus and user-installable or user-deletable applications 575 that are downloaded from an external device or a network and stored in the image display apparatus.

Based on the afore-described platforms illustrated in FIGS. 11 and 12, a variety of Application Programming Interfaces (APIs) and Software Development Kits (SDKs) necessary to develop applications may be opened. APIs may be implemented functions that provide connectivity to specific sub-routines, for execution of the functions within a program. Or APIs may be implemented programs.

For example, sources related to hardware drivers of the OS kernel 410, such as a display driver, a WiFi driver, a Bluetooth driver, a USB driver or an audio driver, may be opened. Related sources within the driver 420 such as a driver for a microcomputer, a display module, a GPU, an FRC, an SDEC, a VDEC, an ADEC or a pointing device may be opened. In addition, sources related to PSIP or SI middleware as broadcasting information-related middleware or sources related to DLNA middleware may be opened.

Such various open APIs allow developers to create applications executable in the image display apparatus 100 or applications required to control operations of the image display apparatus 100 based on the platforms illustrated in FIGS. 11 and 12.

The platforms illustrated in FIGS. 11 and 12 may be general-purpose ones that can be implemented in many other electronic devices as well as in image display apparatuses. The platforms may be stored or loaded in the memory 140, the controller 170, or any other processor. To execute applications, an additional application processor may be further provided.

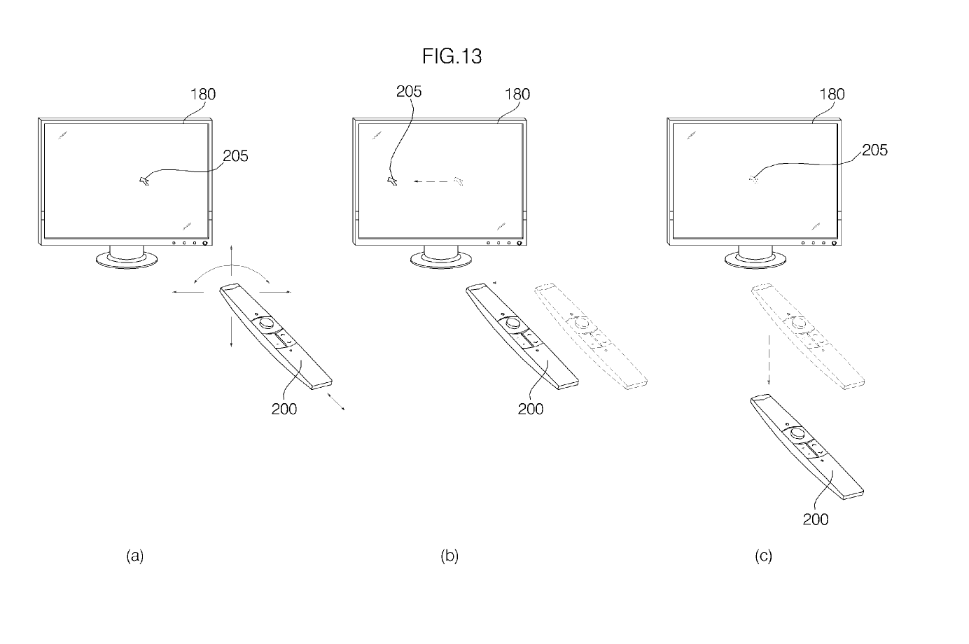

FIG. 13 illustrates a method for controlling either of the image display apparatuses using a remote controller according to an embodiment of the present invention.

FIG. 13(a) illustrates a pointer 205 representing movement of the remote controller 200 displayed on the display 180.

The user may move or rotate the remote controller 200 up and down, side to side (FIG. 13(b)), and back and forth (FIG. 13(c)). Since the pointer 205 moves in accordance with the movement of the remote controller 200, the remote controller 200 may be referred to as a pointing device.

Referring to FIG. 13(b), if the user moves the remote controller 200 to the left, the pointer 205 moves to the left on the display 180. A sensor of the remote controller 200 detects the movement of the remote controller 200 and transmits motion information corresponding to the result of the detection to the image display apparatus. Then, the image display apparatus determines the movement of the remote controller 200 based on the motion information received from the remote controller 200, and calculates the coordinates of a target point to which the pointer 205 should be shifted in accordance with the movement of the remote controller 200 based on the result of the determination. The image display apparatus then displays the pointer 205 at the calculated coordinates.

Referring to FIG. 13(c), while pressing a predetermined button of the remote controller 200, the user moves the remote controller 200 away from the display 180. Then, a selected area corresponding to the pointer 205 may be zoomed in on and enlarged on the display 180. On the contrary, if the user moves the remote controller 200 toward the display 180, the selection area corresponding to the pointer 205 is zoomed out and thus contracted on the display 180. The opposite case is possible. That is, when the remote controller 200 moves away from the display 180, the selection area may be zoomed out and when the remote controller 200 approaches the display 180, the selection area may be zoomed in.

With the predetermined button pressed in the remote controller 200, the up, down, left and right movements of the remote controller 200 may be ignored. That is, when the remote controller 200 moves away from or approaches the display 180, only the back and forth movements of the remote controller 200 are sensed, while the up, down, left and right movements of the remote controller 200 are ignored. Unless the predetermined button is pressed in the remote controller 200, the pointer 205 moves in accordance with the up, down, left or right movement of the remote controller 200.

The speed and direction of the pointer 205 may correspond to the speed and direction of the remote controller 200.

The pointer 205 is an object displayed on the display 180 in correspondence with the movement of the remote controller 200. Therefore, the pointer 205 may have various shapes other than the arrow illustrated in FIG. 13. For example, the pointer 205 may be a dot, a cursor, a prompt, a thick outline, etc. The pointer 205 may be displayed across a plurality of points, such as a line and a surface, as well as at a single point on horizontal and vertical axes.

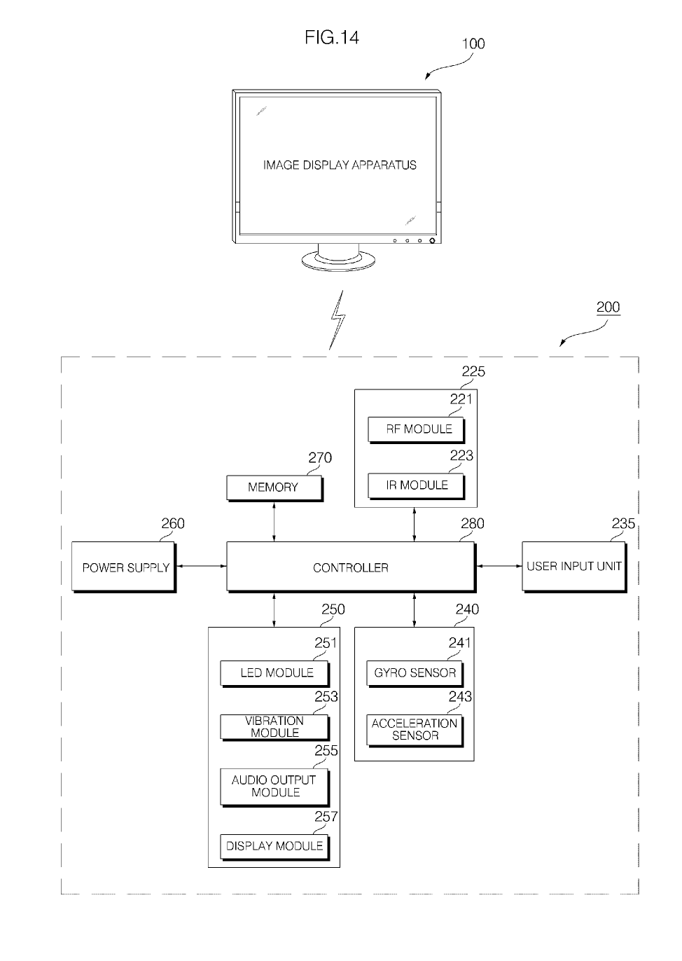

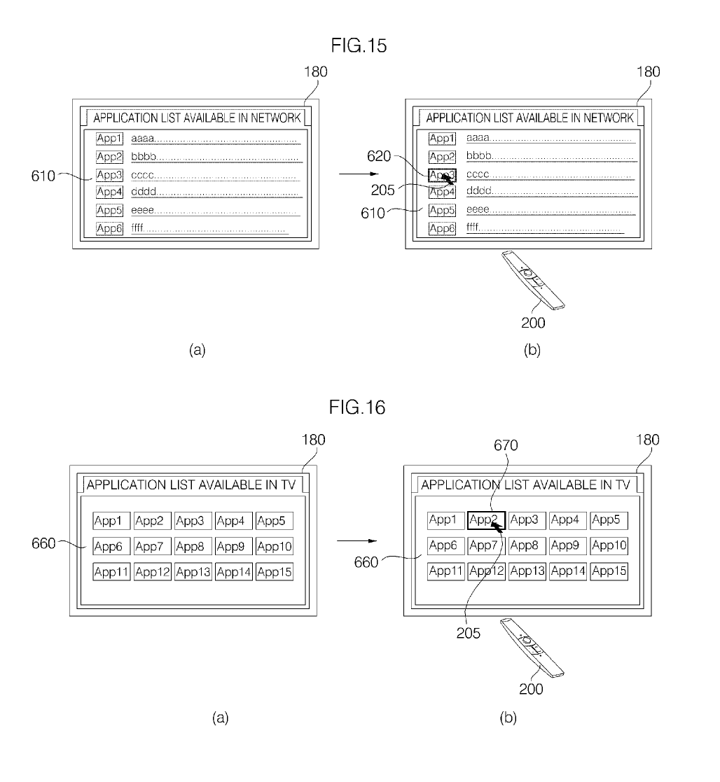

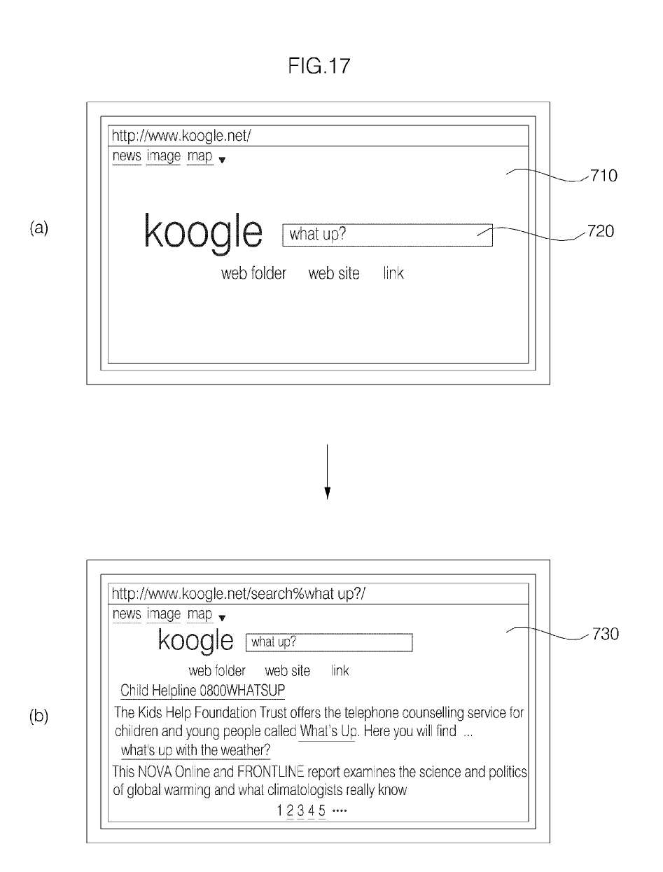

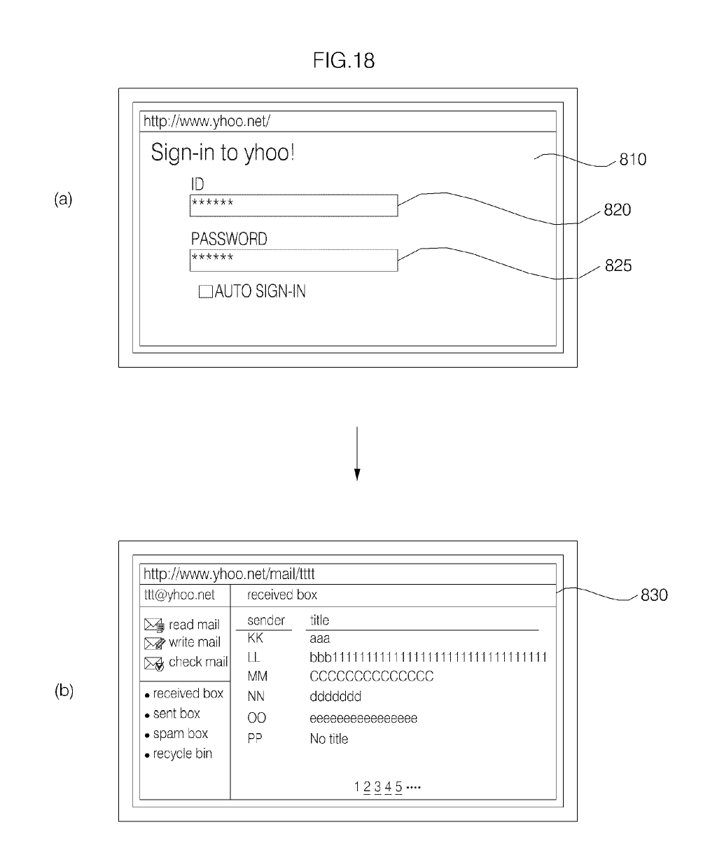

FIG. 14 is a detailed block diagram of the remote controller in either of the image display apparatuses according to an embodiment of the present invention.

Referring to FIG. 14, the remote controller 200 may include a wireless communication module 225, a user input unit 235, a sensor unit 240, an output unit 250, a power supply 260, a memory 270, and a controller 280.

The wireless communication module 225 transmits signals to and/or receives signals from either of the afore-described image display apparatuses according to the embodiments of the present invention, herein, the image display apparatus 100.

The wireless communication module 225 may include an RF module 221 for transmitting RF signals to and/or receiving RF signals from the image display apparatus 100 according to an RF communication standard. The wireless communication module 225 may also include an IR module 223 for transmitting IR signals to and/or receiving IR signals from the image display apparatus 100 according to an IR communication standard.

The remote controller 200 transmits motion information representing the movement of the remote controller 200 to the image display apparatus 100 through the RF module 221 in this embodiment. The remote controller 200 may also receive signals from the image display apparatus 100 through the RF module 221. As needed, the remote controller 200 may transmit commands such as a power on/off command, a channel switch command, or a volume change command to the image display apparatus 100 through the IR module 223.

The user input unit 235 may include a keypad, a plurality of buttons, a touchpad and/or a touch screen. The user may enter commands to the image display apparatus 100 by manipulating the user input unit 235. If the user input unit 235 includes a plurality of hard buttons, the user may input various commands to the image display apparatus 100 by pressing the hard buttons. Alternatively or additionally, if the user input unit 235 includes a touch screen displaying a plurality of soft keys, the user may input various commands to the image display apparatus 100 by touching the soft keys. The user input unit 235 may also include various input tools other than those set forth herein, such as a scroll key and/or a jog wheel, which should not be construed as limiting the present invention.

The sensor unit 240 may include a gyro sensor 241 and/or an acceleration sensor 243. The gyro sensor 241 may sense the movement of the remote controller 200, for example, in X-, Y-, and Z-axis directions, and the acceleration sensor 243 may sense the speed of the remote controller 200. The sensor unit 240 may further include a distance sensor for sensing the distance between the remote controller 200 and the display 180.

The output unit 250 may output a video and/or audio signal corresponding to manipulation of the user input unit 235 or corresponding to a signal received from the image display apparatus 100. The user may easily identify whether the user input unit 235 has been manipulated or whether the image display apparatus 100 has been controlled, based on the video and/or audio signal output by the output unit 250.

The output unit 250 may include a Light Emitting Diode (LED) module 351 which is turned on or off whenever the user input unit 235 is manipulated or whenever a signal is received from or transmitted to the image display apparatus 100 through the wireless communication module 225, a vibration module 253 which generates vibrations, an audio output module 255 which outputs audio data, and/or a display module 257 which outputs video data.

The power supply 260 supplies power to the remote controller 200. If the remote controller 200 is kept stationary for a predetermined time or longer, the power supply 260 may, for example, reduce or shut off supply of power to the spatial remote controller 200 in order to save power. The power supply 260 may resume power supply if a predetermined key on the spatial remote controller 200 is manipulated.

The memory 270 may store various types of programs and application data necessary to control or drive the remote controller 200. The spatial remote controller 200 may wirelessly transmit signals to and/or receive signals from the image display apparatus 100 over a predetermined frequency band with the aid of the RF module 221. The controller 280 of the remote controller 200 may store information regarding the frequency band used for the remote controller 200 to wirelessly transmit signals to and/or wirelessly receive signals from the paired image display apparatus 100 in the memory 270, for later use.

The controller 280 provides overall control to the remote controller 200. The controller 280 may transmit a signal corresponding to a key manipulation detected from the user input unit 235 or a signal corresponding to motion of the spatial remote controller 200, as sensed by the sensor unit 240, to the image display apparatus 100.

FIGS. 15 to 18 illustrate UIs in either of the image display apparatuses according to embodiments of the present invention.

Referring to FIG. 15, an application list available from a network is displayed on the display 180. A user may access a CP or an NP directly, search for various applications, and download the applications from the CP or the NP.

Specifically, FIG. 15(a) illustrates an application list 610 available in a connected server, displayed on the display 180. The application list 610 may include an icon representing each application and a brief description of the application. Because each of the image display apparatuses according to the embodiments of the present invention is capable of full browsing, it may enlarge the icons or descriptions of applications received from the connected server on the display 180. Accordingly, the user can readily identify applications, which will be described later.

FIG. 15(b) illustrates selection of one application 620 from the application list 610 using the pointer 205 of the remote controller 200. Thus, the selected application 620 may be easily downloaded.

FIG. 16 illustrates an application list available in the image display apparatus, displayed on the display 180. Referring to FIG. 16(a), when the user selects an application list view menu by manipulating the remote controller 200, a list of applications 660 stored in the image display apparatus is displayed on the display 180. While only icons representing the applications are shown in FIG. 16, the application list 660 may further include brief descriptions of the applications, like the application list 610 illustrated in FIG. 15. Therefore, the user can readily identify the applications.

FIG. 16(b) illustrates selection of one application 670 from the application list 660 using the pointer 205 of the remote controller 200. Thus, the selected application 670 may be easily executed.

While it is shown in FIGS. 15 and 16 that the user selects a desired application by moving the pointer 205 using the remote controller 200, the application may be selected in many other ways. For example, the user may select a specific application using a cursor displayed on the display 180 by a combined input of a local key and an OK key in the remote controller 200.

In another example, if the remote controller 200 has a touch pad, the pointer 205 moves on the display 180 according to touch input of the touch pad. Thus the user may select a specific menu using the touch-based pointer 205.

FIG. 17 illustrates a Web page displayed on the display 180. Specifically, FIG. 17(a) illustrates a Web page 710 with a search window 720, displayed on the display 180. The user may enter a character into the search window 720 by use of character keys of a keypad displayed on a screen, character keys (not shown) provided as local keys or character keys of the remote controller 200.

FIG. 17(b) illustrates a search result page 730 having search results matching a keyword entered into the search window 720. Since the image display apparatuses according to the embodiments of the present invention are capable of fully browsing a Web page, the user can easily read the Web page.

FIG. 18 illustrates another Web page displayed on the display 180. Specifically, FIG. 18(a) illustrates a mail service page 810 including an ID input window 820 and a password input window 825, displayed on the display 180. The user may enter a specific numeral and/or text into the ID input window 820 and the password input window 825 using a keypad displayed on the mail service page 810, character keys (not shown) provided as local keys, or character keys of the remote controller 200. Hence, the user can log in to a mail service.

FIG. 18(b) illustrates a mail page 830 displayed on the display 180, after log-in to the mail service. For example, the mail page 830 may contains items “read mail”, “write mail”, “sent box”, “received box”, “recycle bin”, etc. In the “received box” item, mail may be ordered by sender or by title.

The image display apparatuses according to the embodiments of the present invention are capable of full browsing when displaying a mail service page. Therefore, the user can use the mail service conveniently.

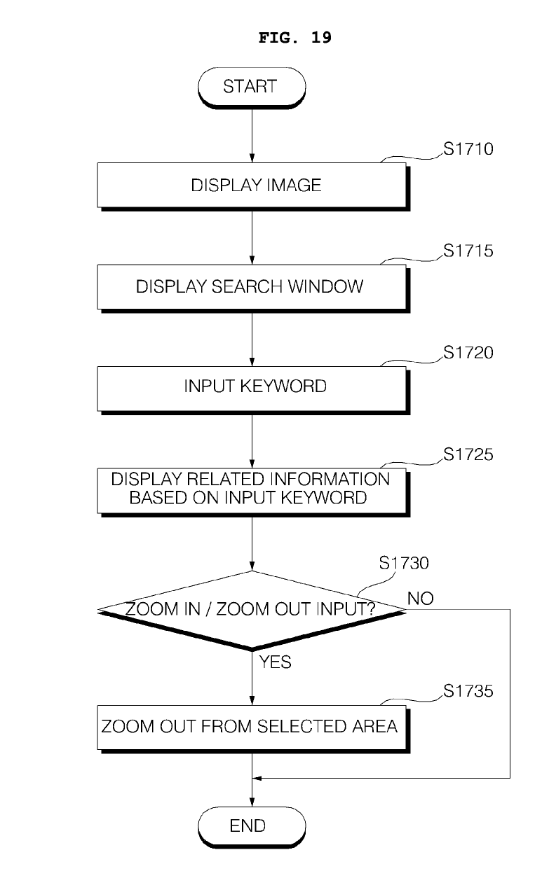

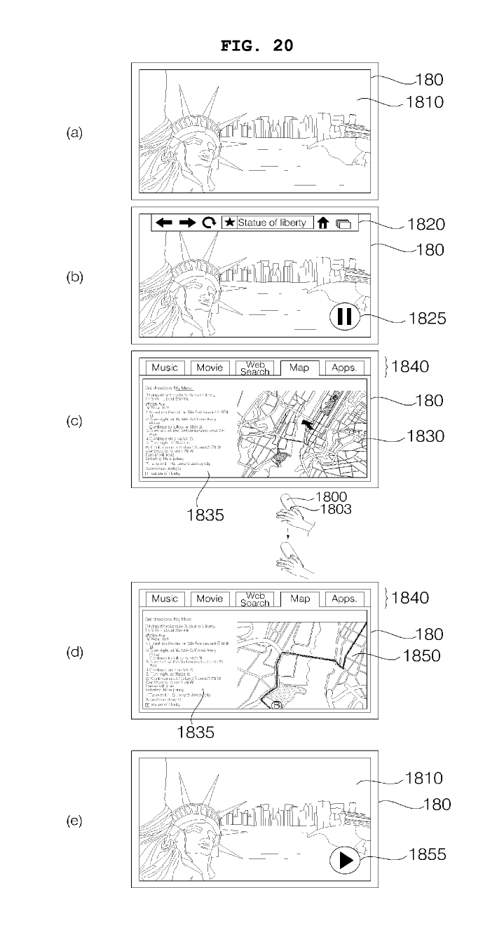

FIG. 19 is a flowchart illustrating a method for operating an image display apparatus according to embodiments of the present invention. FIGS. 20 to 31 are views referred to for describing various examples of a method for operating an image display apparatus, illustrated in FIG. 19.

Referring to FIG. 19, an image may be displayed on the display 180 in step S1710.

The controller 170 performs image processing of broadcast signals, external input signals, or stored signals, and controls a broadcast image, an external input image, or a stored image to be displayed on the display 180. In this case, each image may be a still image or a moving image.

FIG. 20(a) exemplarily shows that a moving image 1810 is displayed on the display 180.

For example, if there is a user input signal, the displayed moving image may be stopped. For a stop function of the moving image, the memory 140 stores a received broadcast image for a predetermined period of time. Then, if a user enters an input signal for the stop function, the operation for storing the received broadcast image may be paused. Thereafter, if the user enters another input signal for playing the broadcast image, the broadcast image starting from the stored position can be temporarily played. This operation function may be called a Digital Video Recorder (DVR) function.

Next, the search window may be displayed on the display in step S1715.

If the user enters a specific input signal for searching for a desired part from among a currently displayed image, the controller 170 displays a search window on the display 180.

The search window may be displayed on an area different from that of the displayed image, or may be partially overlapped with another area.

FIG. 20(b) exemplarily shows that the search window 1820 is displayed in an upper area of the display 180 under the condition that an image is displayed. On the other hand, the stop object 1825 for indicating a paused state of the displayed image may also be displayed if possible. As a result, the user can readily recognize the paused state of the displayed moving image.

Next, the user may enter a keyword in step S1720.

The keyword input can be carried out by any of a local key input from the user, an input signal of a remote controller 1800, or selection of a letter button of a keyboard.

In the meantime, the keyword input may also be carried out by a local key input of the user or a letter button of the remote controller 1800.

In addition, the keyword input may also be carried out by recognition of a user's voice. For this user's voice recognition, the controller 170 may include a voice recognition algorithm. The user's voice signal entered through either the image display apparatus 100 or a microphone of the remote controller 1800 is transferred to the controller 170, and the controller 170 may recognize a user's voice by real-time execution of the corresponding algorithm.

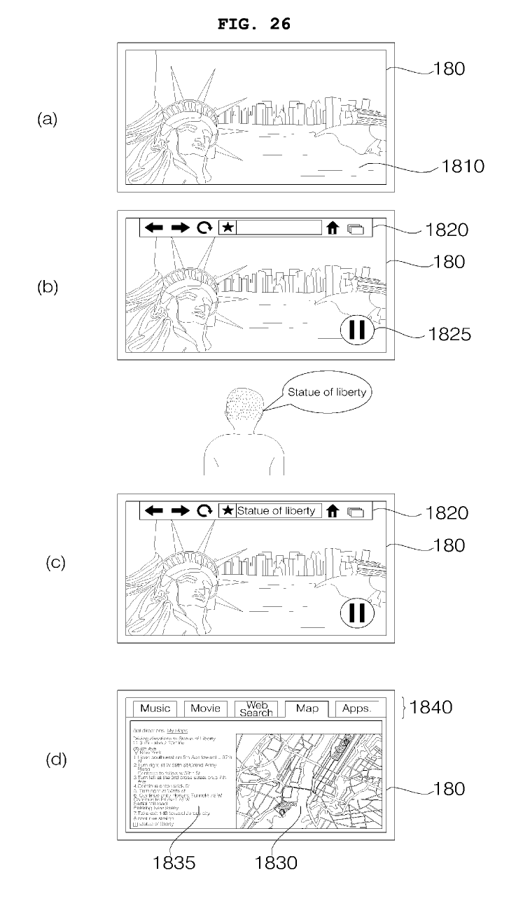

FIG. 26 exemplarily shows a keyword input caused by voice recognition. Under the condition that the image 1810 is displayed [See FIG. 26(a)] and an input window 1820 for entering a keyword is displayed [See FIG. 26(b)], if the user speaks specific words “statue of liberty” related to the displayed image 1810 [See FIG. 26(b)], the corresponding voice is recognized so that the corresponding words “statue of liberty” is displayed on the input window 1820 [See FIG. 26(c)]. Therefore, the menu items 1840 of information related to the input keyword are displayed, and the association information 1830 and 1835 of any one of the menu items 1840 are displayed [See FIG. 26(d)]. FIG. 26(d) exemplarily shows that map information 1830 and details information 1835 of the map are displayed on the display 180.

In addition, the keyword input may be carried out, under the condition that subtitles or broadcast information related to the displayed image are displayed on the display 180, by a user input operation or by user selection of a word from among the displayed subtitles or broadcast image.

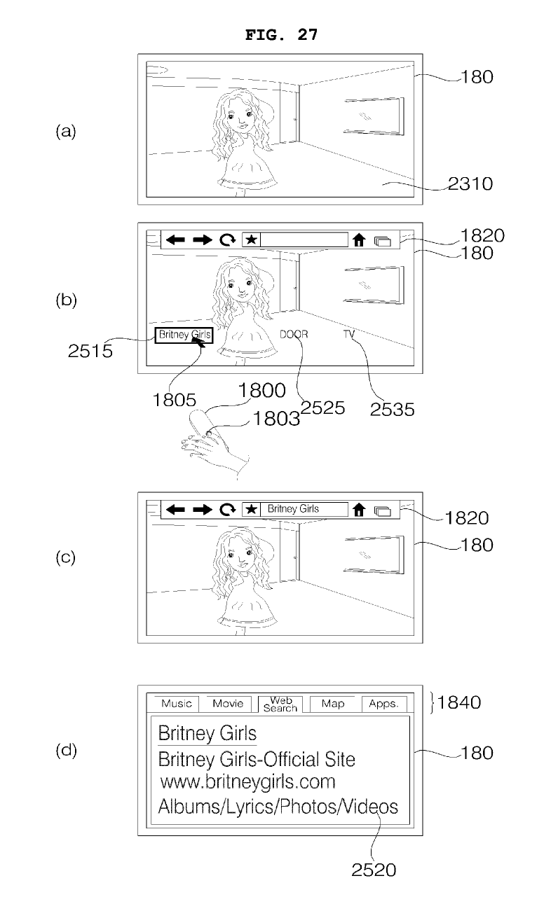

FIG. 27 shows an example of a keyword input caused by subtitle selection. Under the condition that the image 2310 is displayed on the display 180 [See FIG. 27(a)], the input window 1820 for entering a keyword may be displayed and subtitles 2515, 2525 and 2535 associated with the corresponding image may be displayed [See FIG. 27(b)], if the user presses a first button 1803 of the remote controller 1800 using a pointer 1805 of the remote controller 1800 and at the same time selects any one 2515 of the corresponding subtitles [See FIG. 27(b)], the content (“Britney Girls”) of the selected subtitle 2515 is displayed on the input window 1820 [See FIG. 27(c)]. Thereafter, information 2520 associated with the keyword input is displayed [See FIG. 27(d)]. FIG. 27(d) exemplarily shows that Web search information 2520 corresponding to a Web menu item is displayed in the display 180.

In addition, the keyword may also be entered by selection of some parts of the image displayed on the display 180. For example, the image contained in the selected area is searched for in the network of the image display apparatus 100, an image similar to the corresponding image is searched for to recognize the corresponding content, and a keyword may be derived based on the searched image or the recognized corresponding content. Or, by means of metadata added to the image of the selected image, a keyword may be derived using the associated information contained in the metadata.

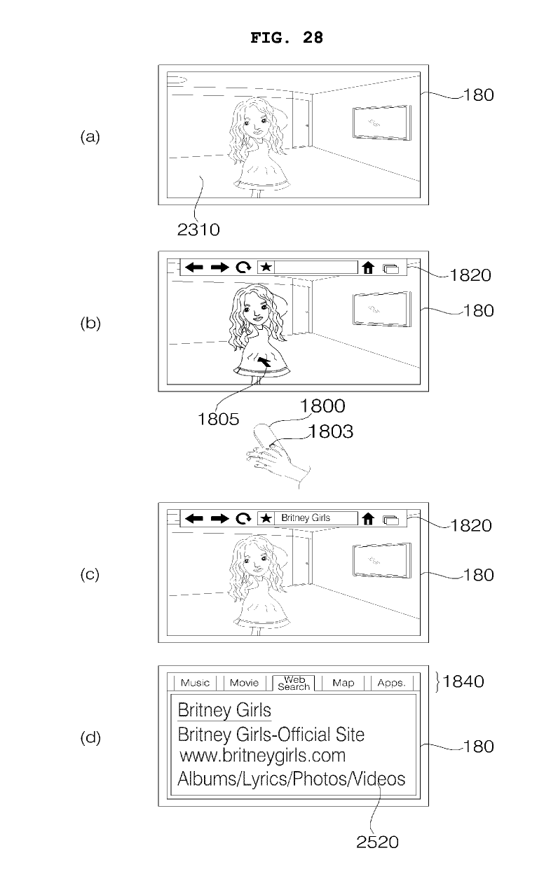

FIG. 28 shows an example of a keyword input caused by selection of some areas contained in the image displayed on the display 180. Under the condition that the image 2310 is displayed on the display 180 [See FIG. 28(a)] and the input window 1820 for entering a keyword is displayed, if the user presses a first button 1803 of the remote controller 1800 and locates the pointer 1805 at a specific area contained in the image 2310, the corresponding specific area is selected and the content (“Britney Girls”) of the selected area is displayed on the input window 1820 [See FIG. 28(c)]. Thereafter, information 2520 associated with the keyword input may be displayed [See FIG. 28(d)]. FIG. 28(d) exemplarily shows that Web search information 2520 corresponding to a Web menu item from among the associated menu items 1840 is displayed on the display 180.

Likewise, when entering the keyword, a desired keyword may be entered using any one of a keyboard displayed on the display 180, user's voice recognition, or subtitle- or broadcast-information associated with the image, such that the user can easily enter his or her desired keyword.

Next, associated information may be displayed on the input keyword in step S1725.

The controller 170 may collect information associated with the displayed image on the basis of the input keyword, and displays the collected information on the display 180.

The associated information may be carried out, in the image display apparatus 100, through an external device 230 connected through an external device interface 230 or an external network connected through the network interface 135. This search result may be directly collected by the controller 170, or may also be collected by a search engine of the external network if necessary.

In the meantime, such associated information may be classified and arranged according to individual menu items, and the associated information of the corresponding menu item may be displayed according to the arranged menu items.

FIG. 20(c) exemplarily shows that menu items 1840 of the associated information, i.e., a music menu item, a movie menu item, a Web search menu item, a map menu item, and an application menu item are arranged at an upper area of the display 180. Menu items 1840 of the associated information may include at least one of the aforementioned exemplary items, the addition or deletion of the menu items 1840 may be possible by user's setup information, and the arrangement order of the menu items 1840 may also be changed according to priority information.

Likewise, the image display apparatus 100 according to embodiments of the present invention, information associated with the input keyword is classified and displayed according to individual menu items, resulting in the increase of the degree of freedom of the user. Specifically, when the image display apparatus 100 is a smart TV as described above, the collected information may be changed in response to a keyword, so that the number of menu items 1840 can be automatically adjusted or can be automatically adjusted according to individual importance levels of the menu items 1840. In addition, by a user's input action, the number of menu items 1840 may be changed or the order of arranging the menu items 1840 may be variable. Therefore, user convenience is increased.

FIG. 20(c) exemplarily shows that information associated with the map menu item from among the menu items 1840 of the associated information is displayed on the display 180. The map menu items from among the menu items 1840 of the associated information may be automatically selected according to the importance of the searched result, or may also be selected by a user input signal.

In the meantime, although FIG. 20(c) exemplarily shows that the map information 1830 and details information 1835 of the map information 1830 are displayed on the display 180, it should also be noted that only the map information 1830 be displayed on the display 180 if necessary. The map information 1830 displayed on the display 180 may be Web-access downloaded information.

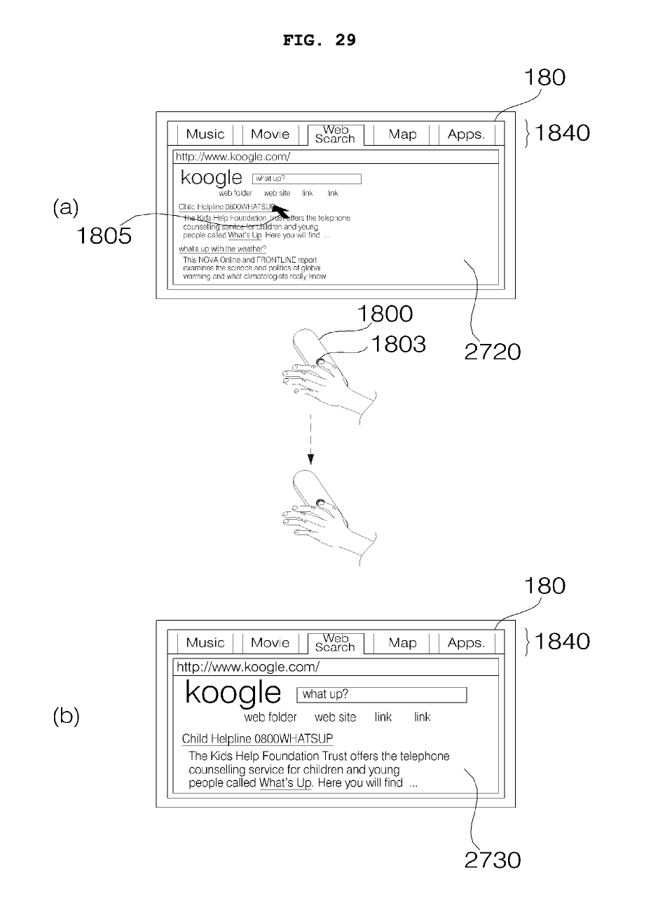

On the other hand, FIG. 29(a) exemplarily shows that the information associated with the Web search menu item from among the items 1840 of the associated information may be displayed on the display 180.

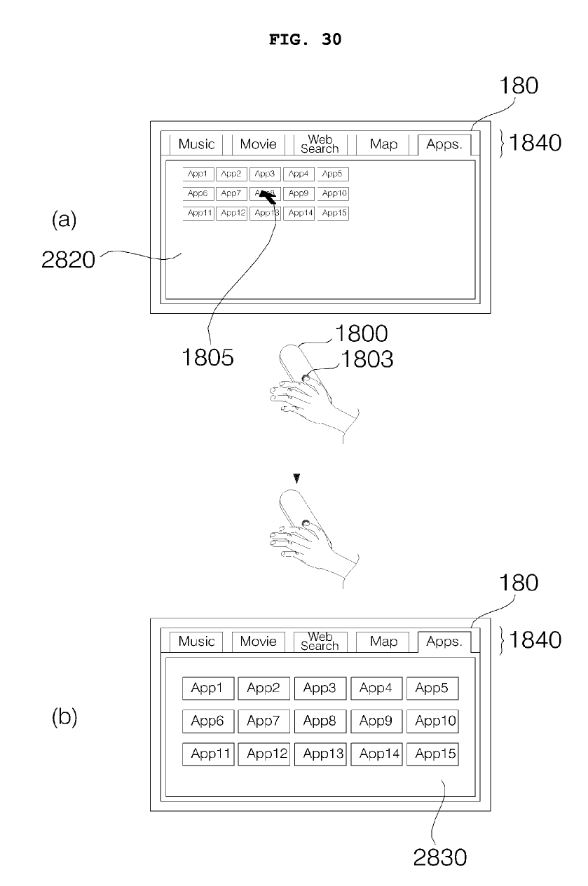

In addition, FIG. 30(a) exemplarily shows that the information 2820 associated with the application menu item from among the menu items 1840 of the associated information is displayed on the display 180. Applications (App1˜App15) that can be downloaded through a network and be stored in the application or the image display apparatus 100 are displayed, such that the corresponding application can be easily used in response to user selection.

As described above, since the associated information of a user-selected menu item is displayed, information desired by the user can be primarily obtained.

On the other hand, from among several menu items, the latest user-selected menu item or a menu item having high frequency of use may also be first displayed as a default item when the search result is displayed. Therefore, although the user does not input an additional selection signal, user-desired information can be primarily obtained automatically in response to a user preference.

Next, it is determined whether there is a zoom-in input or a zoom-output input in step S1730. If there was a zoom-in input or a zoom-output input in step S1730, the zoomed area may be enlarged and displayed in step S1735.

The controller 170, through the remote controller 1800, determines whether a zoom-in or zoom-out input signal is entered by the user.

The remote controller 1800, as described above, includes the sensor unit 240, such that it changes the position of the pointer 1805 in response to the movement of the remote controller 1800.

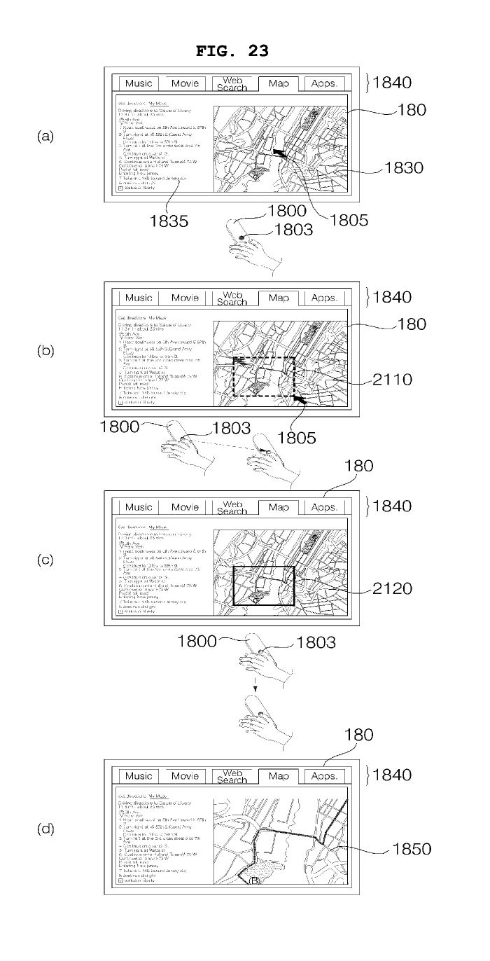

In more detail, the sensor unit 240 may include a gyro sensor 241 and an acceleration sensor 243, such that the gyro sensor 241 may sense the movement of remote controller 180, for example, in X-, Y-, and Z-axis directions, and the acceleration sensor 243 may sense information about the moving speed of the remote controller 1800, etc. The sensor unit 240 may further include a distance sensor for sensing the distance between the remote controller 1800 and the display 180. The sensed result is transmitted to the controller 170 through the user input interface 250. As shown in FIG. 23 and so on, the controller 170 displays the pointer 1805 on the display 180 in response to the movement of the remote controller 1800.

Specifically, while pressing a first button of the remote controller 1800, the user moves the remote controller 1800 away from the display 180. Then, a selected area corresponding to the pointer 1805 may be zoomed in on and enlarged on the display 180. On the contrary, if the user moves the remote controller 1800 toward the display 180, the selection area corresponding to the pointer 205 is zoomed out and thus contracted on the display 180. The opposite case is possible. That is, when the remote controller 1800 moves away from the display 180, the selection area may be zoomed out and when the remote controller 1800 approaches the display 180, the selection area may be zoomed in. With the first button pressed in the remote controller 1800, the up, down, left and right movements of the remote controller 1800 may be ignored. That is, when the remote controller 1800 moves away from or approaches the display 180, only the back and forth movements of the remote controller 1800 are sensed, while the up, down, left and right movements of the remote controller 1800 are ignored.

Under the condition that the first button is not pressed in the remote controller 1800, if the remote controller 1800 moves away from the display 1800 or approaches the display 180, the zoom-in or zoom-out operation is not performed and only the pointer 1805 can move in accordance with the up, down, left or right movement of the remote controller 1800. In the meantime, the first button may be an OK button, a touchpad, or a touch screen.

The zoom-in or zoom-out function will be given below with reference to the drawings from FIG. 20.

Although the drawings from FIG. 20 disclose that the remote controller 1800 includes only the first button 1803 for convenience of description, the scope or spirit of the remote controller 1800 is not limited only thereto, and the remote controller 1800 may further include a second button, etc. as necessary.

FIG. 20(c) exemplarily shows that menu items 1840 of the associated information are displayed in an upper area of the display 180 and the associated information 1830 and 1835 of the map menu item are displayed in a lower area of the display 180. In FIG. 20(c), for example, the associated information is classified into map information 1830 of the keyword “statue of liberty” and details information 1835 of the map menu item.

In this case, when the map information 1830 and the details information 1835 of the map information 1830 are displayed in small size so that the user has difficulty in viewing them, the user who presses the first button 1803 of the remote controller 1800 can move the remote controller 1800 away from the display 180.

Specifically, the user may move the pointer 1805 to the map information 1830 and press the first button 1803 and at the same time perform the zoom-in operation.

Therefore, as shown in FIG. 20(d), the content about the map information serving as the selected area may be enlarged, so that the enlarged map information image 1850 is displayed on the display 180.

If the image display apparatus 100 according to embodiments of the present invention is a smart TV that is capable of full browsing, resolution of the map information 1830 capable of being provided to Web may be increased, so that the zoom-in function for zooming in on the map information 1830 or the content of the details information 1835 is needed. In this case, the zoom-in function can be carried out only using a simple operation of the remote controller 1800, so that user-desired content can be readily recognized, resulting in an increase in user convenience.

On the other hand, if the user enters an exit input for displaying the associated information or an exit input of displaying the zoom-in or zoom-out image through the remote controller 1800, the previous display image 1810 may be re-displayed on the display 180 as shown in FIG. 20(e). In this case, the playback object 1855 for reproducing the stopped moving image may also be displayed on the display 180 as necessary. As a result, the user can simply and easily play back or reproduce the stopped moving image.

On the contrary, as can be seen from FIG. 20(c), indication of the selected area may be performed by the user who locates the pointer 1805 at a specific area and presses the first button 1803 of the remote controller 1800, and various other examples may also be used if necessary.

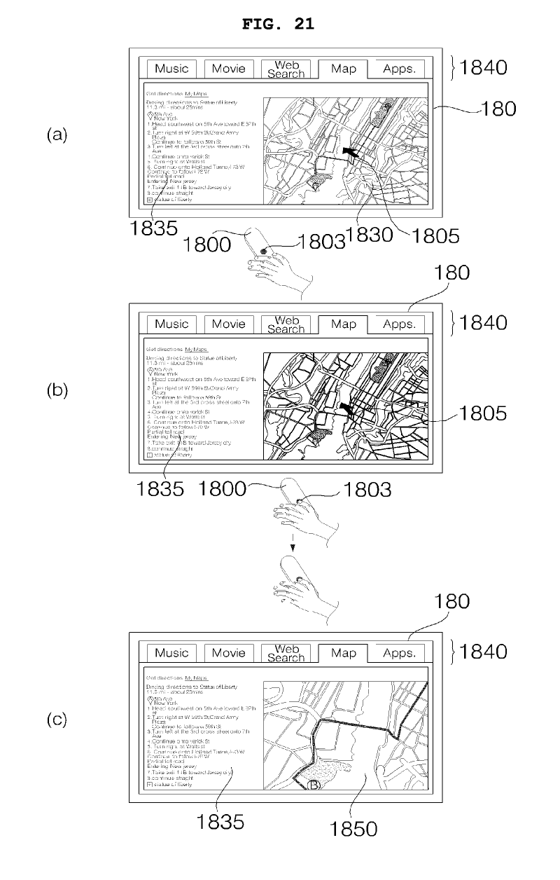

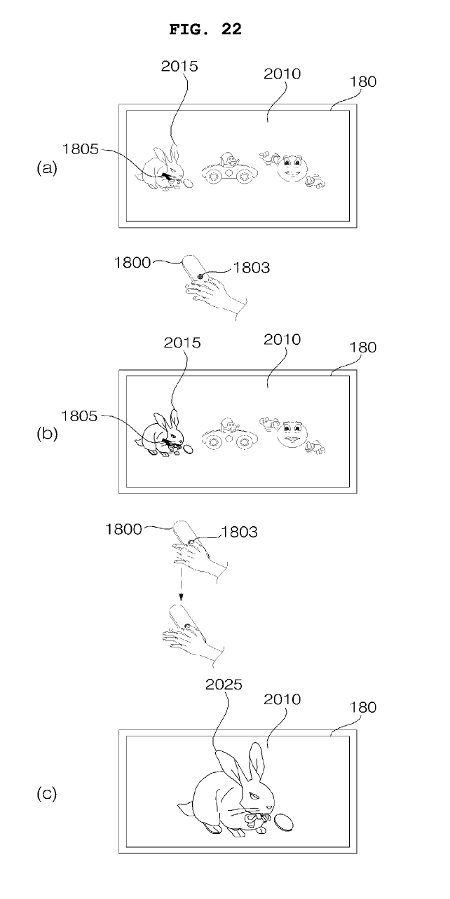

FIGS. 21 and 22 exemplarily show that the image is enlarged on the basis of the pointer.

Under the condition that the menu items 1840 of the associated information are displayed in an upper area of the display 180 and the associated information 1830 and 1835 of the map menu item are displayed in a lower area of the display 180 (See FIG. 21(a)), if the user moves the pointer 1805 to the map information 1830 as shown in FIG. 21(b), presses the first button 1803, and performs the zoom-in operation, map information at which the corresponding pointer is located may be enlarged so that the enlarged map image 1850 is displayed as shown in FIG. 21(c).

On the contrary, if the image 2010 is displayed on the display 180 as shown in FIG. 22(a), under the condition that the pointer 1805 is located in a first area 2015 contained in the image 2010, the user presses the first button 1803 and moves the remote controller 1800 away from the display 180, so that the zoom-in operation can be carried out. As a result, the image may be zoomed in on the first area 2015, so that the enlarged image 2025 is displayed on the display 180 as shown in FIG. 22(c).

On the other hand, FIG. 23 exemplarily shows indication of the selected area.

Under the condition that associated information 1830 and 1835 of the map menu item from among the menu items 1840 of the associated information are displayed on the display 180 (See FIG. 23(a)), the selectable area 2110 can be displayed on the display 180 by the user who presses the first button 1803 of the remote controller 1800 and drags the pointer 1805 from a first position to a second position (See FIG. 23(b)). In this case, if the first position and the second position of the pointer 1805 are not arranged in the same horizontal line or the same vertical line, the rectangular selectable area 2110 may be displayed on the display 180 as shown in FIG. 23. In this case, even when the user presses an additional second button instead of the first button 1803 of the remote controller 1800 and drags the pointer 1805 from the first position to the second position, the selectable area 2110 may also be displayed on the display 180. The second button may be a button for indicating the selection area in a different way from the first button 1803 for the zoom-in or zoom-out function.

As shown in FIG. 23(c), when the user presses the first button 1803 of the remote controller 1800 and moves the remote controller 1800 away from the display 180 so as to perform the zoom-in operation, the selection area 2120 corresponding to the selectable area 2110 may be decided. In addition, the image may be zoomed in on the selection area 2120, so that the enlarged image 1850 is displayed on the display 180.

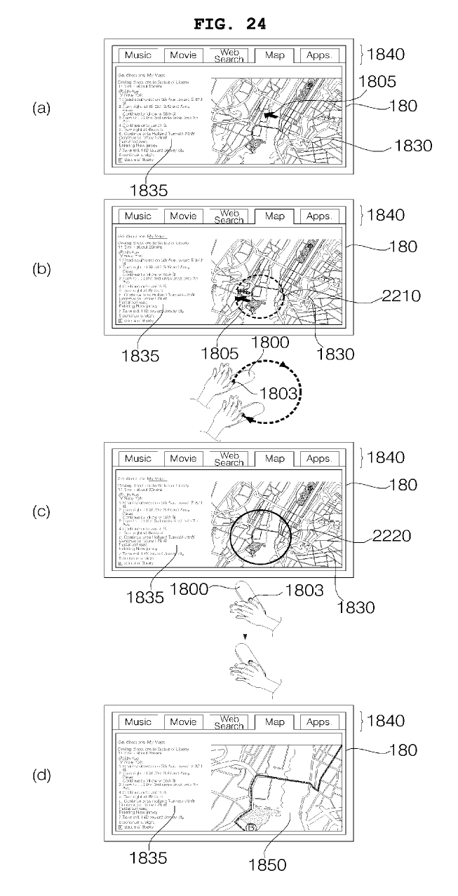

FIGS. 24(a) to 24(d) show another example of the selection area indication.

Under the condition that associated information 1830 and 1835 of the map menu item from among the menu items 1840 of the associated information are displayed on the display 180 as shown in FIG. 24(a), the moving path 2210 may be displayed on the display 180 by the user who presses the first button 1803 of the remote controller 1800 and rotates the remote controller 1800 as shown in FIG. 24(b). That is, the rotation movement path 2210 may be displayed on the display 180. Although FIG. 24 exemplarily shows the rotation movement path, the scope or spirit of the present invention is not limited thereto, and other examples in which the moving path is configured in the form of a closed curve may also be applied to the present invention as necessary. Alternatively, the path may be a quadrilateral or other polygon or shape that completely or partially encloses the area or item of interest. In addition, when the user presses an additional second button instead of the first button 1803 and rotates the remote controller 1800, the moving path 2210 may also be displayed on the display 180. The second button may be a button for indicating the selection area in a different way from the first button 1803 for the zoom-in or zoom-out function.

As shown in FIG. 24(c), the selection area 2220 corresponding to the rotation movement path 2210 may be decided by the zoom-in input action in which the user presses the first button 1803 of the remote controller 1800 and at the same time moves the remote controller 1800 away from the display 180. In addition, the image may be zoomed in on the selection area 2220, such that the enlarged image 1850 is displayed on the display 180.

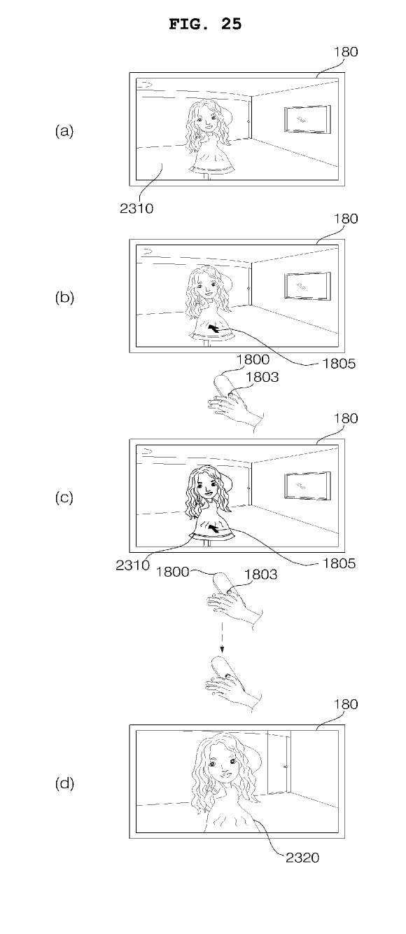

In the meantime, FIG. 25 exemplarily shows that, if an object contained in the displayed image 2310 is selected, the selected object is activated.

Under the condition that the image 2310 is displayed on the display 180 as shown in FIG. 25(a), if the user presses the first button 1803 of the remote controller 1800 and locates the pointer 1805 at a predetermined object of the image as shown in FIG. 25(b), the corresponding object may be activated and displayed as shown in FIG. 25(c).

Such object may be detected through an edge detection function, etc., and may be separately activated in response to the indication of the pointer 1805. As an example of such activation, boundary reinforcement of the corresponding object, highlight display, brightness change, or color change, etc. may be performed. As a result, the user can definitely recognize the selected object.

Thereafter, through the zoom-in input operation in which the user presses the first button 1803 of the remote controller 1800 and at the same time moves the remote controller 1800 away from the display 180, the enlarged image 2320 centering around the selected object may be displayed on the display 180 as shown in FIG. 25(d).

On the other hand, although FIG. 25 has omitted the displaying of associated information items in response to the input keyword, in accordance with the aforementioned description, under the condition that the associated information menu items 1840 and the associated information 1830 and 1835 of the selected menu item (i.e., the map menu item) are displayed as shown in FIG. 20, the activation of the associated information items may also be carried out.

On the other hand, the aforementioned zoom-in or zoom-out operation may be performed on the condition that various items are displayed on the display 180.

FIG. 29(a) exemplarily shows that, under the condition that the menu items 1840 associated with the input keyword are displayed in an upper area of the display 180 and the Web search menu item is selected from among the menu items 1840, the corresponding Web-associated information 2720 is displayed on the display 180.

In addition, through the zoom-in input action in which the user presses the first button 1803 of the remote controller 1800 and moves the remote controller 1800 away from the display 180, the corresponding Web-associated information 2720 may be enlarged such that the enlarged image 2730 is displayed as shown in FIG. 29(b).

When the image display apparatus 100 according to the embodiments of the present invention is a smart TV capable of full browsing, resolution may be increased due to the increased amount of Web-associated information 2720 capable of being provided to Web, such that the zoom-in function about the content of the Web-associated information 2720 is required. In this case, the zoom-in function may be performed using only the simple operation of the remote controller 1800, such that the user can easily recognize his or her desired content, resulting in an increase in user convenience.

In addition, as shown in FIG. 30(a), under the condition that the associated information menu items 1840 in response to the input keyword are displayed in an upper area of the display 180 and the application item (Apps.) is selected from among the menu items 1840, the corresponding application associated information 2820 may be displayed on the display 180.

In addition, through the zoom-in input action in which the user presses the first button 1803 of the remote controller 1800 and moves the remote controller 1800 away from the display 180, the corresponding application associated information 2820 may be enlarged such that the enlarged image 2830 is displayed as shown in FIG. 30(b). In this way, applications capable of being downloaded through the network may be enlarged and displayed, resulting in an increase in user convenience.

On the contrary, although FIG. 30 exemplarily shows that the corresponding application associated information 2820 includes an icon indicating each application, the scope or spirit of the present invention is not limited thereto and the present invention may further include brief information of each application as necessary. As a result, the user can easily recognize the corresponding application.

On the other hand, under the condition that the corresponding application associated information 2820 is displayed, the user may select a desired application using the pointer 1830 of the remote controller 1800. As a result, the corresponding application can be simply and easily performed.

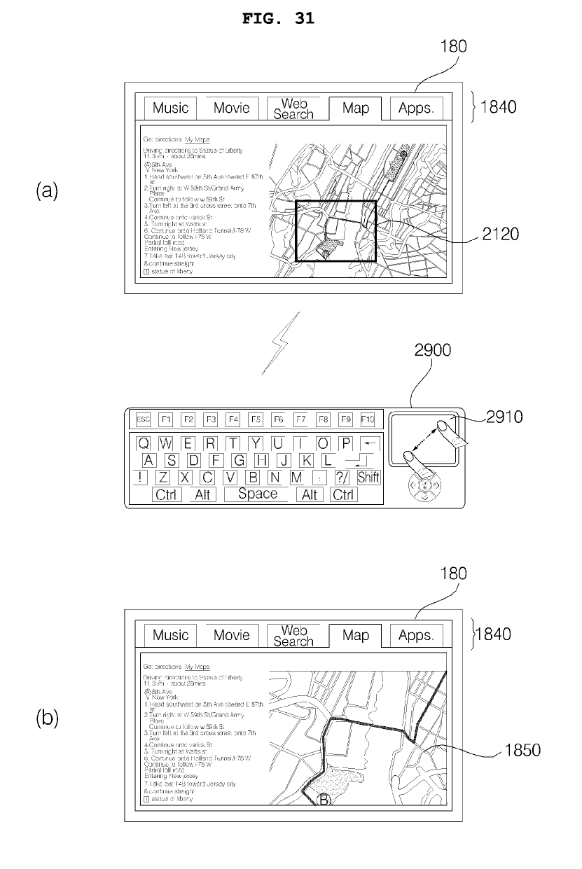

FIG. 31 shows an example of item selection caused by a touchpad 2910 of a remote controller 2900.

FIG. 31(a) exemplarily shows that information associated with the map menu item from among the associated information menu items 1840 searched by the input keyword is displayed on the display 180.

In addition, FIG. 31(a) exemplarily shows that the user performs multiple-touching action using the touchpad 2910 of the remote controller 2900. In particular, FIG. 31(a) exemplarily shows the enlargement touching using two fingers of the user.

Therefore, as shown in FIG. 31(b), the enlarged image 1850 may be displayed on the display 180. On the contrary, if a predetermined area 2120 is selected from among the map information as shown in FIG. 31(a), the selected area may be enlarged on the basis of the selection area 2120.

On the other hand, differently from FIG. 31, the image may be zoomed in using a specific key (+) of the remote controller or may be zoomed out using another key (−) of the remote controller. In this case, the zoom-in or zoom-out of the image may be performed stepwise. For example, the image obtained when the (+) key is operated twice may be further enlarged as compared to another case in which the (+) key is operated once,

The aforementioned stepwise enlarging or contracting display of the image may also be applied to one case of the remote controller 2900 for use with the touchpad 2910 or another case of the other remote controller 1800 shown in FIGS. 21 to 30.

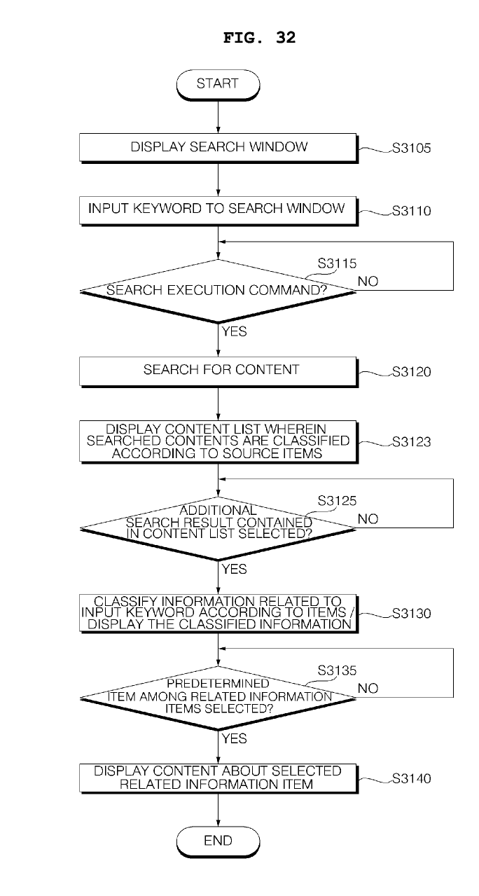

Referring to FIG. 32, the content search window is displayed in step S3105. The controller 170 may control the content search window to be displayed in a first area of the display 180 upon receiving a control signal from a local key or the remote controller, etc. For example, the content search window may be displayed in an upper area of the display 180.

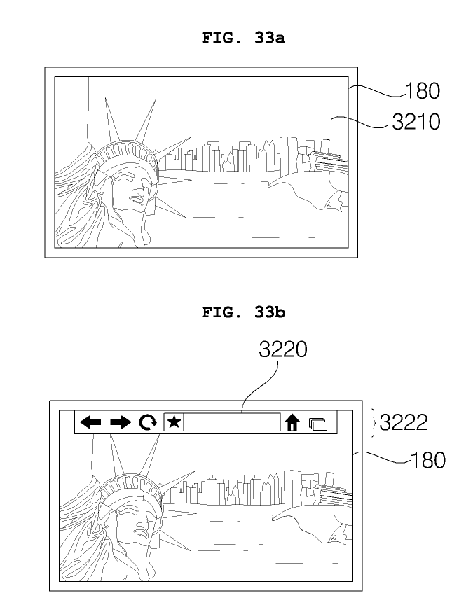

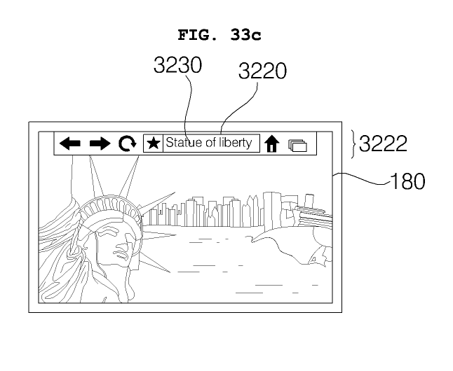

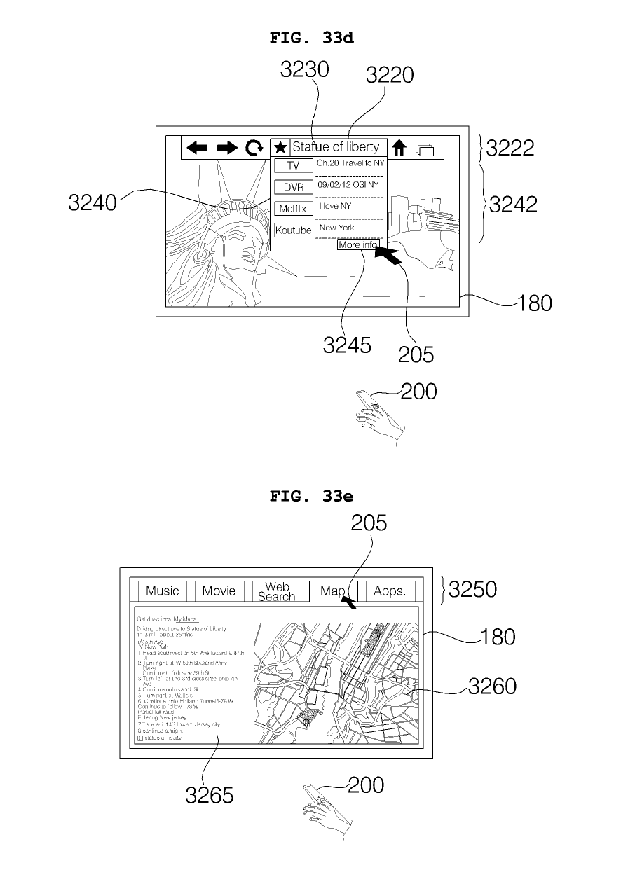

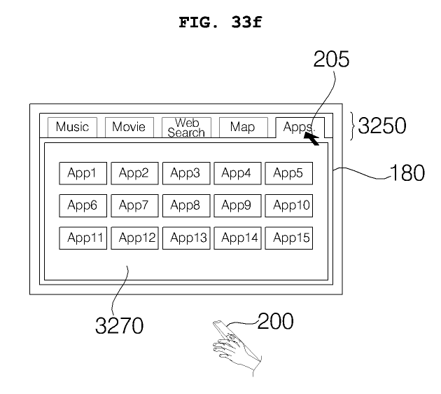

FIG. 33A exemplarily shows that the image 3210 is displayed on the display 180. FIG. 33B exemplarily shows that the content search window 3220 is displayed on a first area 3222 of the display 180. The content search window 3220 may be displayed by a local key input or a predetermined input of the remote controller 200.

On the other hand, the image 3210 displayed on the display 180 may be an image associated with the reproduced or playback content. For example, the image 3210 may be any one of a broadcast image, an external input image, an audio file playback associated image, a still image, an accessed Web image, or a document file, etc.

Next, the user enters the content keyword in the search window in step S3110. In this case, the controller 170 may invite the user to enter a content keyword in the search window.

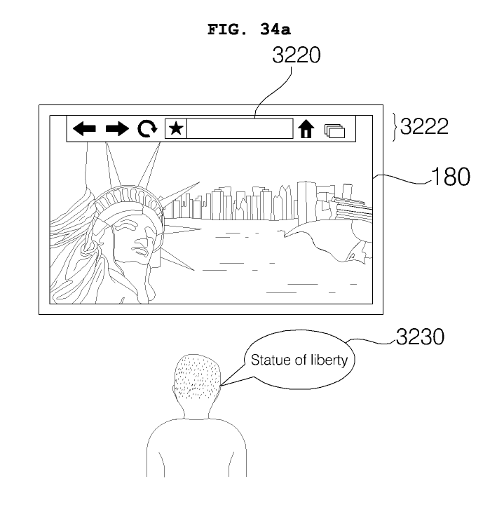

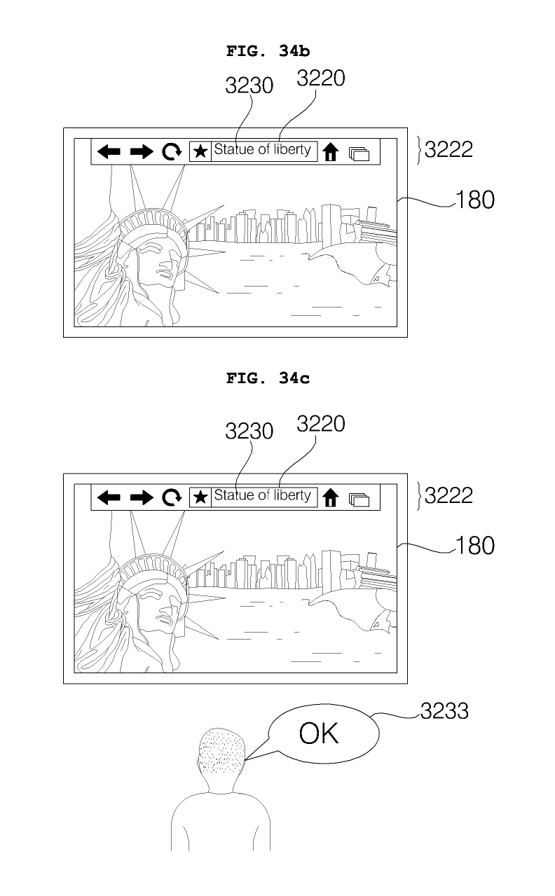

FIG. 33C exemplarily shows that the user enters a content keyword “Statue of Liberty” 3230 in the search window 3220 displayed in the first area 3222 of the display 180. For example, if there is a user voice signal, the controller 170 may detect the user voice signal, and recognize the user voice signal using a predetermined keyword according to the voice recognition algorithm, etc. In addition, through selection of some areas contained in the displayed image, a content keyword associated with the selected area may be input. Various examples about the content keyword input will hereinafter be described with reference to the drawings from FIG. 34A.

Next, the controller 170 determines whether there is a command for search execution in response to an input keyword in step S3115. The search execution command may be entered by the user through a ‘confirmation’ (OK) or ‘enter’ key of the remote controller 200, etc.

If there is a search execution command, content is searched for in step S3120. The searched content may be capable of being reproduced or played back. In addition, the content list formed when the searched content is classified according to source items is displayed in step S3123. Such a content list may be displayed in a second area of the display 180 differently from the search window.

FIG. 33D exemplarily shows that, under the condition that the content search window 3220 is displayed in the first area 3222 of the display 180, the searched content 3240 in which contents are classified according to source items may be displayed in a second area 3242 of the display 180. The content list 3240 may be a pull-down menu or a pop-up menu in the vicinity of the search window 3220 in which the content keyword 3230 “Statue of Liberty” 3230 is displayed. In the drawings, the pull-down menu is exemplarily shown.

The content list 3240 may be classified according to source items of the searched content, such that the classified result is displayed. FIG. 33D exemplarily shows a ‘TV’ item serving as broadcast image content, a ‘DVR’ item serving as inner content of the image display apparatus, a ‘Metflix’ item serving as a content provider over a network, and a ‘Kotube’ item serving as a content provider over a network. As described above, the items are displayed while being classified according to source items, such that the user can easily recognize the searched content.

In the meantime, in response to the input keyword, the number of source items of the searched content of the content list 3240 may be changed and displayed, or the order of source items may be changed and displayed as necessary. For example, when the input keyword is a movie title or an actor or actress name, the number or order of the source items of the searched result in response to the corresponding keyword may be changed.

On the contrary, the content list 3240 may further include not only the source items of the searched content but also an additional search result item 3245 for viewing the additional search result.

Next, the controller 170 determines whether the additional search result item 3245 contained in the content list is selected in step S3125. The controller 170, through the local key or the pointer 205 of the remote controller 200, determines whether the additional search result item (“More Info”) 3245 is selected as shown in FIG. 33D.

If the additional search result item is selected in step S3124, the associated information of the input keyword may be classified and displayed according to items in step S3130. In addition, the controller 170 determines whether a predetermined item is selected from among the associated information items in step S3135. If the predetermined item was selected from among the associated information items, the content about the selected associated information item may be displayed in step S3140.

FIG. 33E exemplarily shows that the associated information of the input keyword is classified and displayed according to items. The associated information menu items 3250 may be displayed in one area (e.g., an upper area) of the display 180.

Although such associated information menu items 3250 include a music menu item ‘Music’, a movie menu item ‘Movie’, a Web-search menu item ‘Web Search’, a map menu item ‘Map’, and an application menu item ‘Apps’, the scope or spirit of the present invention is not limited thereto and various examples may also be used as necessary.

In addition, the number of the associated information menu items 3250 may be changed according to a keyword or an amount of associated information, or the associated information menu items 3250 may be arranged in regular sequence according to predetermined priority and thus the arranged resultant items are displayed. If necessary, according to predetermined setup information, specific information may be added to or deleted from the associated information menu items 3250.

On the other hand, FIG. 33E exemplarily shows that the user selects the ‘Map’ menu item from among the associated information menu items 3250 using the pointer 205 of the remote controller 200. Therefore, the map image 3260 serving as the associated information of the ‘Map’ menu item and details information 3265 of the map may be displayed on the display 180.

Similar to FIG. 33E, FIG. 33F shows that, under the condition that the associated information of the input keyword is classified and displayed according to items, if the application item ‘Apps’ is selected from among the associated information menu items 3250, applications 3270 that can be stored in the image display apparatus 100 or downloaded from an external device or an external network are displayed on the display 180.

Such applications may be classified into applications incapable of being installed or deleted or other applications capable of being installed or deleted.

In addition, a desired application may be selected from among the applications using the pointer of the remote controller 200. As a result, user convenience is increased.

FIGS. 34A to 36C illustrate various examples of the keyword input step S3110 shown in FIG. 32.

Referring to FIG. 34A, an image is displayed on the display 180, and a search window 3220 for entering a keyword may also be displayed. If the user voice signal is detected, the search window 3220 may be displayed on the display 180. If the user voice is detected through an audio sensing unit (e.g., a microphone), the controller 170 may control the search window 3220 for searching for content to be displayed in a first area 3222 of the display 180. In this case, only when a specific voice signal (e.g., a search) of the user is detected, it may also be possible to display the search window 3220 on the display 180.

Under the condition that the search window 3220 is displayed, if the user speaks specific words “statue of liberty” 3230, the controller 170 recognizes the corresponding voice signal using the voice recognition algorithm, etc. In this case, if the same voice signal is repeated at least twice, it is possible to enter the content keyword such that a correct keyword can be extracted through the voice signal of the user.

In addition, as shown in FIG. 34B, the keyword “statue of liberty” 3230 may be displayed on the search window 3220 contained in the first area 3222 of the display 180.

Under the condition that a keyword is input to the keyword window, if there is a search execution command by a local key input or a control signal input from the remote controller 200, the controller 170 searches for at least one of the memory 340 of the image display apparatus 100, a content provider (CP) through the network interface 330, peripheral external devices through the external device interface 335. For the searching, the search engine may be contained in the controller 170 or the search engine on the network may be used as necessary.

In the meantime, the search execution command may also be entered by a user voice signal as necessary. FIG. 34 exemplarily shows that the search execution command is entered on the basis of the predetermined voice signal established by the user. Although FIG. 34 exemplarily defines a specific word ‘OK’ as the user setup voice signal, other words or terms may also be used in the present invention without any restriction if necessary. As a result, the content keyword and the search execution command can be entered only by the user voice signal.

In addition, as shown in FIG. 34D, the content list 3240 in which the searched content is classified according to source items may be displayed as the search result. Similar to FIG. 33D, the content list 3240 may be displayed while being classified according to source items of the searched content. In other words, the content list 3240 may include a ‘TV’ item, a ‘DVR’ item, a ‘Metflix’ item, and a ‘Kotube’ item, and content information of individual items may also be displayed.

The content list 3240 may further include an additional search result item 3245 for viewing the additional search result.

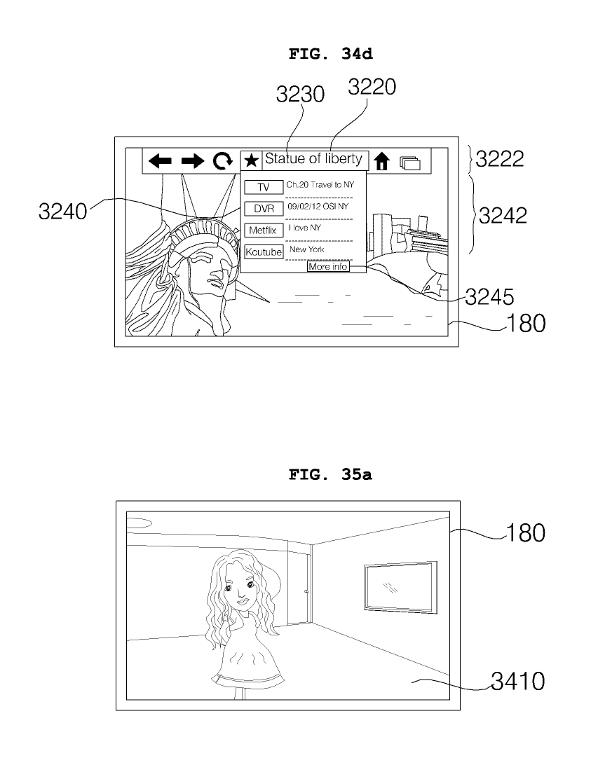

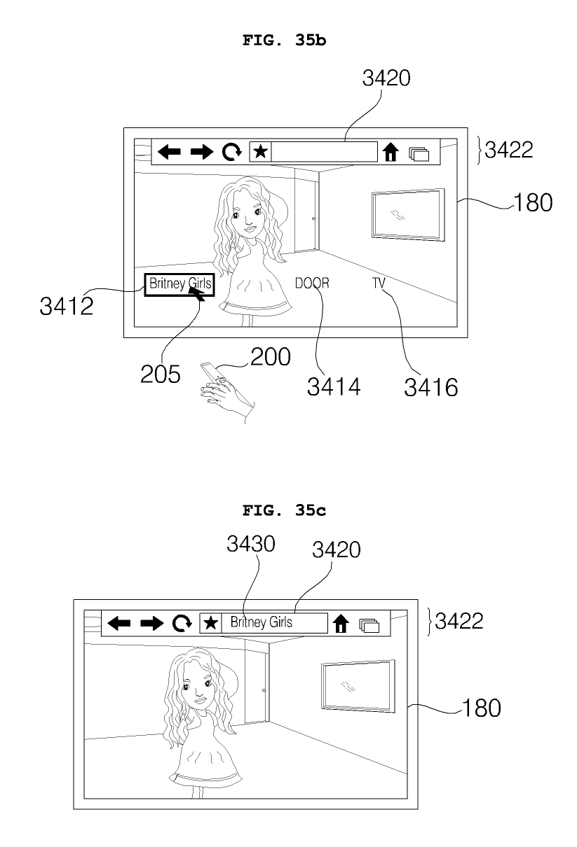

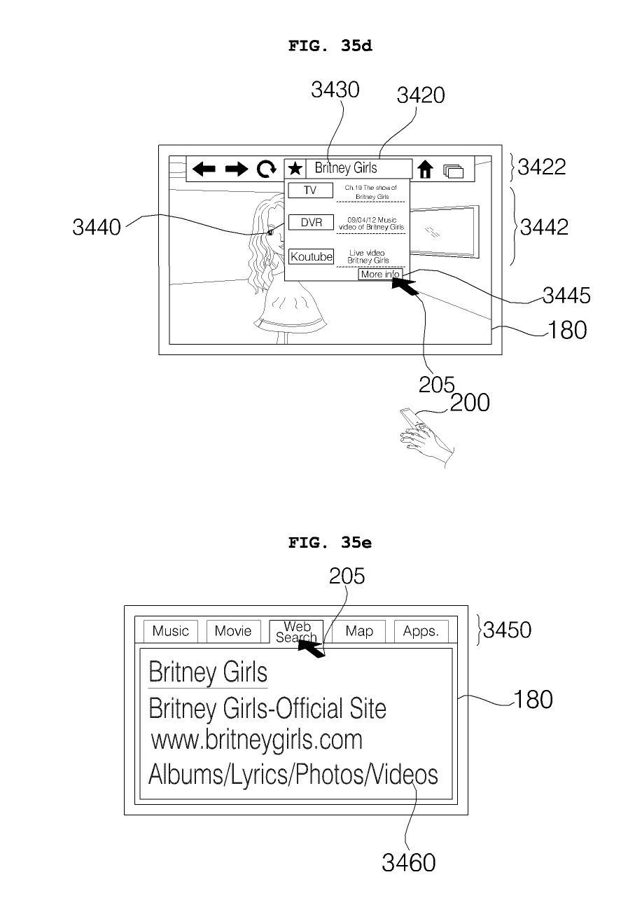

Next, after the image 3410 is displayed on the display 180 as shown in FIG. 35A, the search window 3420 for a keyword input and subtitles 3412, 3414 and 3416 associated with the corresponding image may be displayed as shown in FIG. 35B. The search window 3420 for a keyword input may be displayed in a first area 3422 (i.e., an upper area) of the display 180.

In this case, if the user selects any one (“Britney Girls”) of subtitles from among the subtitles 3412, 3414 and 3416 using the pointer 205 of the remote controller 200, the keyword (“Britney Girls”) 3430 can be simply and readily input to the search window 3420 displayed in the first area 3422 of the display 180 as shown in FIG. 35C.

In addition, in accordance with the search execution command, as shown in FIG. 35D, the content list 3440 in which the searched content is classified according to source items may be displayed as the search result in a second area 3442 of the display 180. In this case, the corresponding keyword 3430 may be displayed in the search window 3420 without any change.

On the other hand, the keyword of FIG. 35D is different from that of FIG. 34D, such that the number of source items of the searched content may be reduced to 3.

If the user selects the additional search result item 3445 for viewing the additional search result using the pointer 205 of the remote controller 200, the associated information items 3450 may be displayed in one area (i.e., upper area) of the display 180 as shown in FIG. 35E.

Such associated information items 3450 may include a ‘Music’ item, a ‘Movie’ item, a ‘Web Search’ item, a ‘Map’ item, and an application (Apps.) item.

In this case, if the ‘Web Search’ item is selected from among the associated information items 3450 using the pointer 205 of the remote controller 200, the Web search information 3460 associated with the keyword (“Britney Girls”) may be displayed on the display 180.

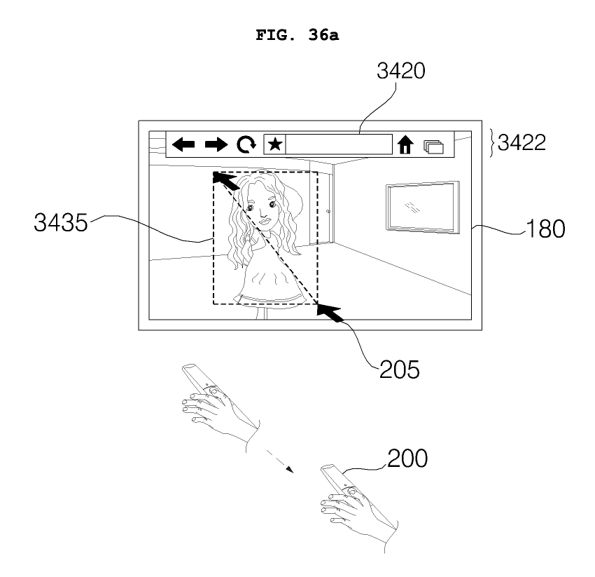

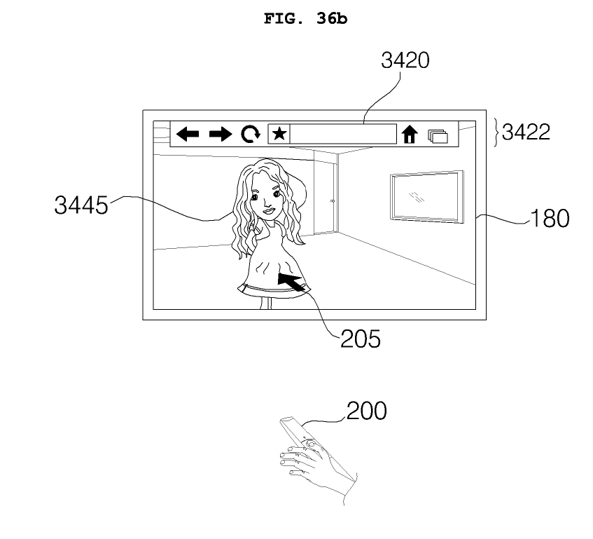

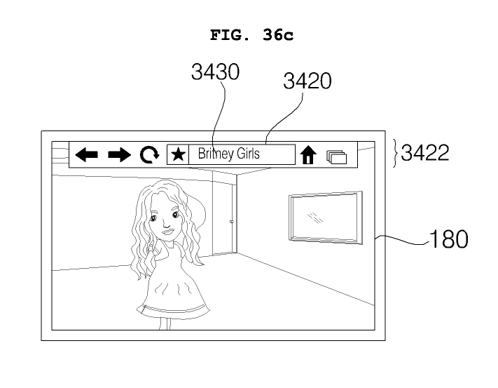

Next, under the condition that the search window 3420 is displayed in a first area 3422 of the display 180 as shown in FIG. 36e, some areas of the displayed image may be selected using the pointer 205 of the remote controller 200. If the user performs the dragging from a first point to a second point on the displayed image, FIG. 36A exemplarily shows that the corresponding area 3435 is selected.

Thereafter, under the condition that the search window 3420 is displayed in the first area 3422 of the display 180 as shown in FIG. 36B, some areas of the displayed image may be selected using the pointer 205 of the remote controller 200. FIG. 36B exemplarily shows that, under the condition that some areas of the image are selected, the corresponding area 3445 is selected. In this case, the selected area 3445 may be activated by edge (or outline) variation or brightness variation, etc.

The selection areas 3435 and 3445 in FIGS. 36A and 36B may be adapted to derive a keyword using the image detection algorithm, etc. For example, the image contained in the selection area may be searched for in the network, an image similar to the corresponding image is searched for such that content of the searched image can be recognized and the keyword can be derived. In addition, by means of metadata added to the image of the selection area, the keyword may also be derived using the associated information contained in the metadata.

In addition, the derived keyword (“statue of liberty”) 3430 may be displayed on the search window 3420 as shown in FIG. 36C.

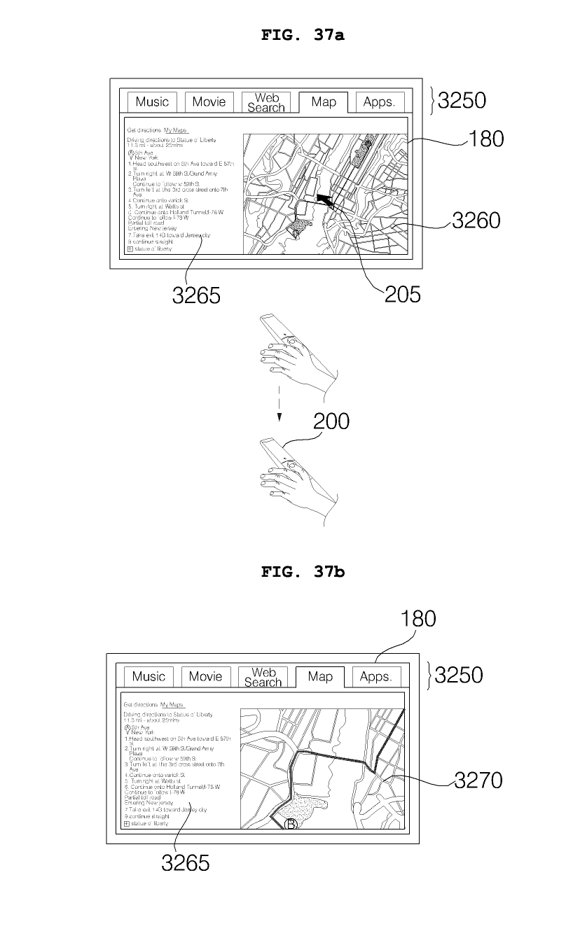

FIGS. 37A to 37B illustrate exemplary zoom-in or zoom-out operation using the remote controller.

FIG. 37A exemplarily shows that, under the condition that the ‘Map’ item is selected from among the associated information items 3250, the map image 3260 serving as the associated information of the ‘Map’ item and details information of the map are displayed on the display 180. In addition, FIG. 37A exemplarily shows that the remote controller 200 is moved away from the display 180.

The controller 170 controls the selection area to be zoomed in according to the moving operation of the remote controller 200. The selection area may be selected by the pointer 205 of the remote controller 200. FIG. 37A exemplarily shows the map image 3260 as the selection area.

In more detail, the gyro sensor 241 may sense the movement of remote controller 200 in X-, Y-, and Z-axis directions, and the acceleration sensor 243 may sense information about the moving speed of the remote controller 200, etc. The sensor unit 240 may further include a distance sensor for sensing the distance between the remote controller 200 and the display 180. The sensed result is transmitted to the controller 170 through the user input interface 150.

Specifically, under the condition that the user presses the first button of the remote controller 200, when the remote controller 200 moves away from the display 180, the selection area may be zoomed out, and when the remote controller 200 approaches the display 180, the selection area may be zoomed in. The opposite case is also possible. That is, with the first button pressed in the remote controller 200, when the remote controller 200 approaches the display 180, the selection area may be zoomed in, or when the remote controller 200 moves away from the display 180, the selection area may be zoomed out. In this case, the up, down, left and right movements of the remote controller 200 may be ignored. That is, when the remote controller 200 moves away from or approaches the display 180, only the back and forth movements of the remote controller 200 are sensed, while the up, down, left and right movements of the remote controller 1800 are ignored.

FIG. 37B exemplarily shows that the selection area 3260 of the remote controller 200 may be zoomed in so that the enlarged map image 3270 is displayed. As a result, the user can easily recognize the associated information.

Although FIG. 37 does not enlarge the details information 3265 of the map image, the entire area other than the selection area can also be enlarged.

The image display apparatus and the method for operating the same according to the foregoing exemplary embodiments are not restricted to the exemplary embodiments set forth herein. Therefore, variations and combinations of the exemplary embodiments set forth herein may fall within the scope of the present invention.

The method for operating an image display apparatus according to the foregoing exemplary embodiments may be implemented as code that can be written on a computer-readable recording medium and thus read by a processor. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission over the Internet). The computer-readable recording medium can be distributed over a plurality of computer systems connected to a network so that computer-readable code is written thereto and executed therefrom in a decentralized manner. Programs, code, and code segments to realize the embodiments herein can be construed by one of ordinary skill in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

As is apparent from the above description of the embodiments of the present invention, if there is a zoom-in or zoom-output input signal for an image, an image display apparatus and a method for operating the same according to the present invention can zoom in on the image or zoom out from the image, such that the user can easily recognize user-desired content, resulting in an increase in user convenience.

The zoom-in or zoom-out operation is performed when the remote controller moves away from the display or approaches the display, resulting in an increase in user convenience.

On the other hand, the image display apparatus or the method for operating the same according to the present invention can simply and easily point out a selection area in response to the dragging movement or rotation movement path of the pointer of the remote controller, such that it can display the zoom-in or zoom-out result, resulting in an increase in user convenience.

In addition, the image display apparatus or the method for operating the same according to the present invention can select an object contained in an image, and can zoom in on or zoom out from the selected object, resulting in an increase in user convenience.

On the other hand, although a first button of the remote controller is pressed and there is at least one of the up, down, left, and right movements of the remote controller, if the remote controller moves away from the display and approaches the display, the image display apparatus or the method for operating the same according to the present invention can display only the zoom-in or zoom-out result, resulting in an increase in user convenience.

Especially, under the condition that associated information in response to a keyword input associated with the displayed image is displayed on the display, the image display apparatus or the method for operating the same according to the present invention can zoom in on or zoom out from the corresponding image.

On the other hand, in the case of entering a keyword, the image display apparatus or the method for operating the same according to the present invention can search for a keyword using a keyboard displayed on the display, voice recognition, or subtitle- and broadcast-information associated with the image, such that the user can easily enter a desired keyword.

Meanwhile, the image display apparatus or the method for operating the same according to the present invention can perform a search function in response to a keyword input to the search window, classify the content list in response to the search result according to source items, and display the classified list, such that the user can simply and easily recognize the classified result for each source item, resulting in an increase in user convenience.

The image display apparatus or the method for operating the same according to the present invention can change the number of content source items contained in the displayed content list in response to an input keyword, or change the order of source items, such that it can effectively display the search result.

When viewing the additional search result, the image display apparatus or the method for operating the same according to the present invention can change the number of associated information items in response to an input keyword or an amount of associated information, or change the order of associated information items, such that it can effectively display the associated information indicating the search result.

In addition, the image display apparatus or the method for operating the same according to the present invention can establish the number of items and the priority of such items, resulting in an increase in user convenience. Especially, the image display apparatus or the method for operating the same can display an application capable of being downloaded over a network, such that the corresponding application can be easily used according to a user selection signal.

Meanwhile, the method for operating the image display apparatus according to the present invention can provide a variety of user interfaces to the image display apparatus, resulting in an increase in user convenience.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for operating an image display apparatus configured to receive a television broadcast from one of a landline, a satellite and another connection, the method comprising:
displaying an image on the image display apparatus;
displaying a pointer on the image, the pointer corresponding to an orientation or position of a remote controller relative to the image display apparatus;
selecting, in response to a first command from the remote controller, an object or an area in the displayed image; and
displaying, in response to a second command from the remote controller, a zoom-in or zoom-out of the selected object or area in the displayed image.

2. The method of claim 1, wherein the step of selecting comprises:
detecting when the pointer is dragged from a first position to a second position on the display, the first position and the second position being two points in a shape circumscribing at least a portion of the object or area.

3. The method of claim 1, wherein the step of selecting comprises:
detecting when a movement of the pointer is one of a circle, an oval or polygon around the object or area.

4. The method according to claim 1, wherein the step of displaying a zoom-in or zoom-out includes detecting a movement of the remote controller.

5. The method of claim 1, wherein the step of selecting comprises:
changing an image characteristic of the selected object or area in the displayed image.

6. The method of claim 1, wherein the step of displaying a zoom-in or zoom-out comprises:
centering the selected object or area in the displayed image.

7. The method of claim 1, wherein the step of displaying a zoom-in or zoom-out comprises:
detecting a signal from the remote controller corresponding to a drag movement on a touchscreen of the remote controller.

8. The method of claim 1, further comprising:
receiving a user search start command, and displaying a search term input display with the image;
receiving a user search term, and displaying the user search term in the search term input display;
receiving a user search command, and searching for content related to the user search term; and
displaying the content related to the search term.

9. The method of claim 8, wherein the step of receiving a user search term comprises:
receiving the user search term as a voice input.

10. The method of claim 8, wherein the step of receiving a user search term comprises:
receiving the user search term via metadata obtained in response to a user selection of the displayed image.

11. An image display apparatus configured to receive a television broadcast from one of a landline, a satellite and another connection, comprising:
a display screen; and
a controller,
wherein the controller is programmed to
display an image on the display screen;
display a pointer on the image, the pointer corresponding to an orientation or position of a remote controller relative to the image display apparatus;
select, in response to a first command from the remote controller, an object or an area in the displayed image; and
display, in response to a second command from the remote controller, a zoom-in or zoom-out of the selected object or area in the displayed image.

12. The image display apparatus of claim 11, wherein the controller is programmed to:
detect when the pointer is dragged from a first position to a second position on the display, the first position and the second position being two points in a shape circumscribing at least a portion of the object or area.

13. The image display apparatus of claim 11, wherein the controller is programmed to:
detect when a movement of the pointer is one of a circle, an oval or polygon around the object or area.

14. The image display apparatus of claim 11, wherein the controller is programmed to display the zoom-in or zoom-out upon detecting a movement of the remote controller.

15. The image display apparatus of claim 11, wherein the controller is programmed to change an image characteristic of the selected object or area in the displayed image.

16. The image display apparatus of claim 11, wherein the controller is programmed to display the zoom-in or zoom-out upon centering the selected object or area.

17. The image display apparatus of claim 11, wherein the controller is programmed to display the zoom-in or zoom-out upon detecting a signal from the remote controller corresponding to a drag movement on a touchscreen of the remote controller.

18. The image display apparatus of claim 11, wherein the controller is programmed to:
receive a user search start command, and display a search term input display with the image;
receive a user search term, and display the search term in the user search term input display;
receive a user search command, and search for content related to the user search term; and
display the content related to the user search term.

19. The image display apparatus of claim 18, wherein the controller is programmed to receive the user search term as a voice input.

20. A non-transitory computer readable medium including instructions configured to cause an image display apparatus configured to receive a television broadcast from one of a landline, a satellite and another connection to perform the following steps:
displaying an image on the image display apparatus;
displaying a pointer on the image, the pointer corresponding to an orientation or position of a remote controller relative to the image display apparatus;
selecting, in response to a first command from the remote controller, an object or an area in the displayed image; and
displaying, in response to a second command from the remote controller, a zoom-in or zoom-out of the selected object or area in the displayed image.
